(19) United States
(12) Patent Application Publication
(10) Pub. No.: US 2023/0072763 A1
(43) Pub. Date: Mar. 9, 2023

(54) INSTANT DATA PACKET TRANSMISSION METHOD AND APPARATUS THEREFOR

(71) Applicant: ELECTRONICS AND TELECOMMUNICATIONS RESEARCH INSTITUTE, Daejeon (KR)

(72) Inventor: Jae Heung KIM, Sejong (KR)

(73) Assignee: ELECTRONICS AND TELECOMMUNICATIONS RESEARCH INSTITUTE, Daejeon (KR)

(21) Appl. No.: 17/799,119

(22) PCT Filed: Mar. 24, 2021
(86) PCT No.: PCT/KR2021/003635

§ 371 Date: Aug. 11, 2022

(30) Foreign Application Priority Data
Mar. 26, 2020 (KR) 10-2020-0037018
Apr. 9, 2020 (KR) 10-2020-0043413
Jul. 9, 2020 (KR) 10-2020-0084856
Jul. 17, 2020 (KR) 10-2020-0088921
Sep. 3, 2020 (KR) 10-2020-0112603
Oct. 16, 2020 (KR) 10-2020-0134528
Oct. 22, 2020 (KR) 10-2020-0137723
Nov. 12, 2020 (KR) 10-2020-0151160
Jan. 7, 2021 (KR) 10-2021-0002165

(51) Int. Cl. H04W 74/08; H04W 74/00; H04W 76/20

(52) U.S. Cl. CPC H04W 74/0841; H04W 74/002; H04W 76/20

(57) ABSTRACT

An instant message transmission method performed by a terminal may comprise the steps of: receiving, from a base station, configuration information related to transmission of an instant message; if an instant message has been generated, determining whether or not the transmission of the instant message is allowed; and if the transmission of the instant message is allowed, transmitting the instant message by using a random access (RA) procedure or one or more pre-allocated uplink resources (PURs).

### TECHNICAL FIELD

The present disclosure relates to a method and an apparatus for transmitting an instant data packet, and more specifically, to a method and an apparatus for transmitting an intermittently occurring instant data packet in a cellular mobile communication system using a high frequency band of a millimeter wave (mmWave) or higher.

### BACKGROUND ART

In order to cope with the rapidly increasing wireless data, a mobile communication system considers a transmission frequency band of 6 GHz to 90 GHz for a wide system bandwidth. In such a high frequency range, a small base station is assumed due to deterioration of reception signal performance due to path loss and reflection of radio waves.

In order to deploy a mobile communication system based on small base stations having small service coverages in consideration of the millimeter wave frequency band of 6 GHz to 90 GHz, a functional split method in which functions of a base station are configured as being split into a plurality of remote radio transmission and reception blocks and one centralized baseband processing block may be applied instead of deploying small base stations in which all of radio protocol functions of the mobile communication system are implemented. In addition, a method of configuring the mobile communication system by utilizing a plurality of transmission and reception points (TRPs) using functions such as a carrier aggregation, dual connectivity, duplication transmission, and the like may be considered.

The present disclosure proposes a radio resource management procedure and a control signaling method for transmitting instant message packets that occur intermittently in the mobile communication system to which such the functional split, bi-casting function, or duplication transmission function is applied.

### DISCLOSURE

### Technical Problem

An objective of the present disclosure for solving the above-described problem is to provide an operation method of a terminal for transmitting an instant message.

Another objective of the present disclosure for solving the above-described problem is to provide an operation method of a base station for receiving an instant message.

Yet another objective of the present disclosure for solving the above-described problem is to provide a terminal apparatus for transmitting an instant message and a base station apparatus for receiving an instant message.

### Technical Solution

An exemplary embodiment of the present disclosure for achieving the objective, as an instant message transmission method performed by a terminal, may comprise: receiving configuration information related to instant message transmission from a base station; determining whether transmission of an instant message is allowed when the instant message occurs; and in response to determining that the transmission of the instant message is allowed, performing the transmission of the instant message by using a random access (RA) procedure or a pre-allocated uplink resource(s) (PUR(s)).

The instant message may be intermittently occurring data or signaling information having a size equal to or less than a predetermined size.

In the performing of the transmission of the instant message, when the terminal is in a radio resource control (RRC) connected state or maintains uplink physical layer synchronization, the transmission of the instant message may be performed by using the PUR(s).

In the performing of the transmission of the instant message, when the terminal is in an RRC inactive or RRC idle state or does not maintain uplink physical layer synchronization, the transmission of the instant message may be performed by using the RA procedure without transition of the terminal to an RRC connected state.

In the performing of the transmission of the instant message, when the terminal is in an RRC inactive or RRC idle state, or does not maintain uplink physical layer synchronization, and the PUR(s) are PUR(s) in which instant message transmission of a terminal not maintaining uplink physical layer synchronization is allowed, the transmission of the instant message may be performed by using the PUR(s).

An RA occasion and/or an RA preamble used in the RA procedure may be configured differently from an RA occasion and/or an RA preamble of an RA procedure which is not for instant message transmission.

The RA preamble used in the RA procedure may vary according to a size of the instant message and/or a channel quality between the terminal and the base station.

The method may further comprise, when the RA procedure is performed as a 4-step RA procedure, transmitting information indicating a size of the instant message and whether the instant message is transmitted one-time or as segmented to the base station by using an RA MSG3 according to the 4-step RA procedure or a control message after the RA MSG 3; receiving allocation information of an uplink resource for transmission of the instant message from the base station through an RA MSG 4 according to the 4-step RA procedure or a separate control message; and transmitting the instant message to the base station using the uplink resource.

The method may further comprise, when the RA procedure is performed as a 2-step RA procedure, transmitting information indicating a size of the instant message and whether the instant message is transmitted one-time or as segmented to the base station by using an RA payload of an RA MSG-A according to the 2-step RA procedure; receiving allocation information of an uplink resource for transmission of the instant message from the base station through an RA MSG-B according to the 2-step RA procedure; and transmitting the instant message to the base station using the uplink resource.

The configuration information may include information on whether the base station allows the RA procedure to be performed as a 2-step RA procedure or information on a radio channel quality condition for the terminal to perform the RA procedure as the 2-step RA procedure.

The PUR(s) may be composed of physical uplink shared channel (PUSCH) resource(s) allocated to the terminal in a CG (configured grant) scheme.

The PUR(s) may be composed of a PUSCH resource(s) and a preamble having a predetermined sequence, a reference signal, or pilot symbols.

The PUR(s) may be configured for each area composed of at least one base station, and the PUR(s) may be configured to the terminal together with an identifier identifying an area to which the PUR(s) are applied.

When the transmission of the instant message is performed by using the PUR(s), if the transmission of the instant message is not completed within a predetermined instant message transmission period, the transmission of the instant message transmission may be determined as failed.

An exemplary embodiment of the present disclosure for achieving the another objective, as an instant message reception method performed by a base station, may comprise: transmitting configuration information related to instant message transmission to a terminal; and in response to determining that the terminal in which an instant message occurs is allowed to transmit the instant message, receiving the instant message by using a random access (RA) procedure or a pre-allocated uplink resource(s) (PUR(s)).

In the receiving of the instant message, when the terminal is in a radio resource control (RRC) connected state or maintains uplink physical layer synchronization, the receiving of the instant message may be performed by using the PUR(s).

In the receiving of the instant message, when the terminal is in an RRC inactive or RRC idle state, or does not maintain uplink physical layer synchronization, the receiving of the instant message may be performed by using the RA procedure without transition of the terminal to an RRC connected state.

An RA occasion and/or an RA preamble used in the RA procedure may be configured differently from an RA occasion and/or an RA preamble of an RA procedure which is not for instant message transmission.

The method may further comprise, when the RA procedure is performed as a 4-step RA procedure, receiving information indicating a size of the instant message and whether the instant message is transmitted one-time or as segmented from the terminal by using an RA MSG3 according to the 4-step RA procedure or a control message after the RA MSG 3; transmitting allocation information of an uplink resource for reception of the instant message to the terminal through an RA MSG 4 according to the 4-step RA procedure or a separate control message; and receiving the instant message from the terminal using the uplink resource.

The method may further comprise, when the RA procedure is performed as a 2-step RA procedure, receiving information indicating a size of the instant message and whether the instant message is transmitted one-time or as segmented from the terminal by using an RA payload of an RA MSG-A according to the 2-step RA procedure; transmitting allocation information of an uplink resource for transmission of the instant message to the terminal through an RA MSG-B according to the 2-step RA procedure; and receiving the instant message from the terminal using the uplink resource.

### Advantageous Effects

According to the exemplary embodiments of the present disclosure, an instant message occurring intermittently in the terminal may be efficiently transmitted to the base station in consideration of an operation state of the terminal. In addition, errors that may occur in transmission of the instant message may also be easily overcome, thereby improving the performance of the system.

### DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating another exemplary embodiment of a communication system.

FIG. 4 is a conceptual diagram illustrating an exemplary embodiment of a method of configuring bandwidth parts (BWPs) in a communication system.

FIG. 5 is a conceptual diagram illustrating an exemplary embodiment of operation states of a terminal in a communication system.

FIG. 6 is a sequence chart illustrating a method of transmitting an instant message based on a 4-step random access procedure according to an exemplary embodiment of the present disclosure.

FIG. 7 is a sequence chart illustrating a method of transmitting an instant message based on a 2-step random access procedure according to an exemplary embodiment of the present disclosure.

### MODES OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, preferred exemplary embodiments of the present invention will be described in detail with reference to the accompanying drawings. In describing the present invention, to facilitate the entire understanding, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

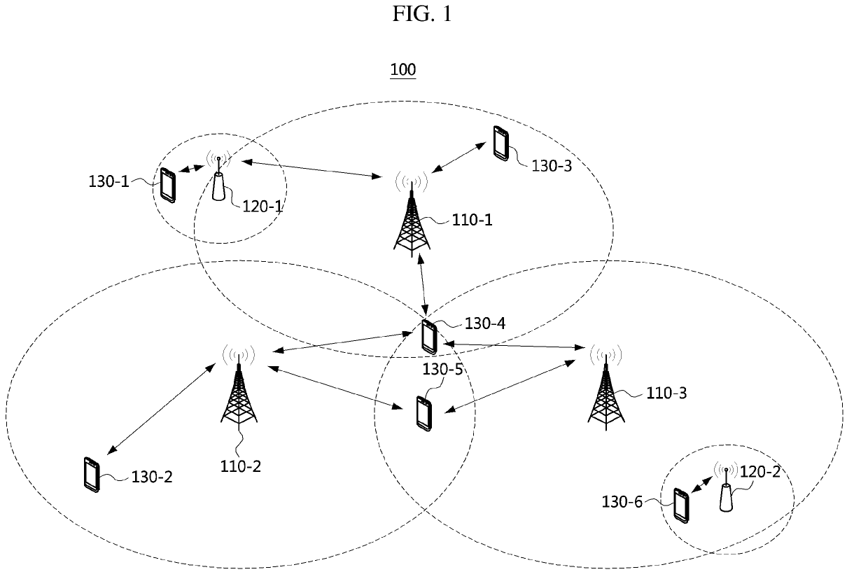

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

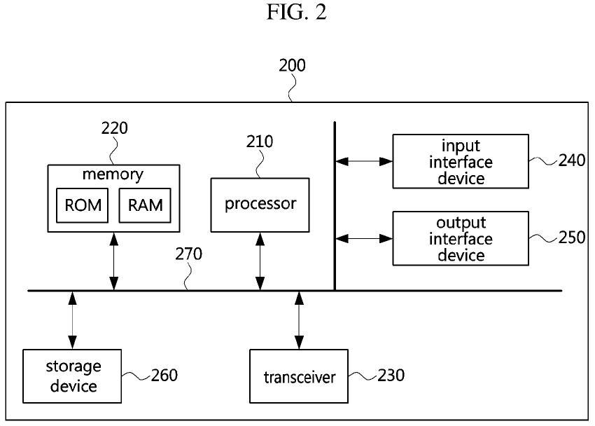

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

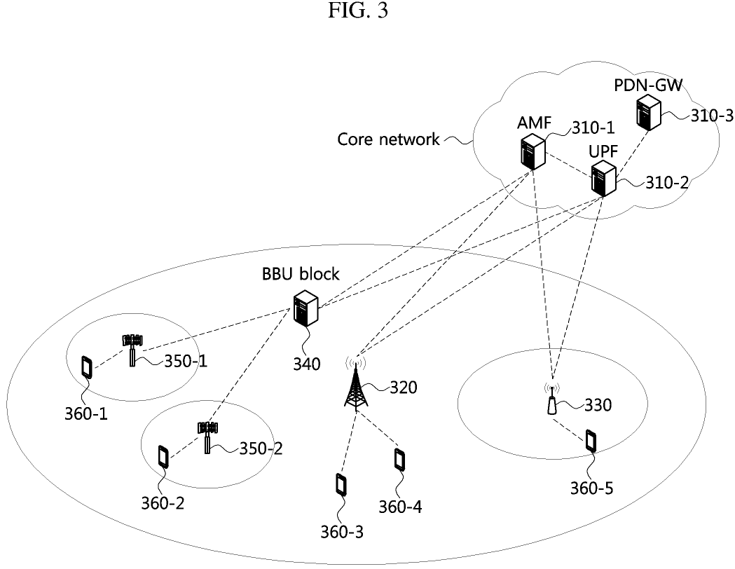

FIG. 3 shows a connection method (example) between a base station and a core network in a wireless communication network using fronthaul and backhaul. In a wireless communication network, a base station 310 (or macro base station) or a small base station 330 is connected to a termination node 340 of the core network through a wired backhaul 380. Here, the termination node of the core network may be a serving gateway (SGW), a user plane function (UPF), a mobility management entity (MME), or an access and mobility function (AMF).

In addition, when a function of the base station is configured as being split in to a baseband processing function block 360 (e.g., baseband unit (BBU) or cloud platform) and a remote radio transmission/reception node 320 (e.g., remote radio head (RRH), transmission & reception point (TRP)), they are connected through a wired fronthaul 370.

The functions of the baseband processing function block 360 may be located in the base station 310 that supports a plurality of remote radio transmit/receive nodes 320 or may be configured as logical functions in the middle of the base station 310 and the SGW/MME (or UPF/AMF) 340 to support a plurality of base stations. In this case, the functions of the baseband processing function block 360 may be physically configured independently of the base station 310 and the SGW/MME 340 or operated as being installed in the base station 310 (or SGW/MME 340).

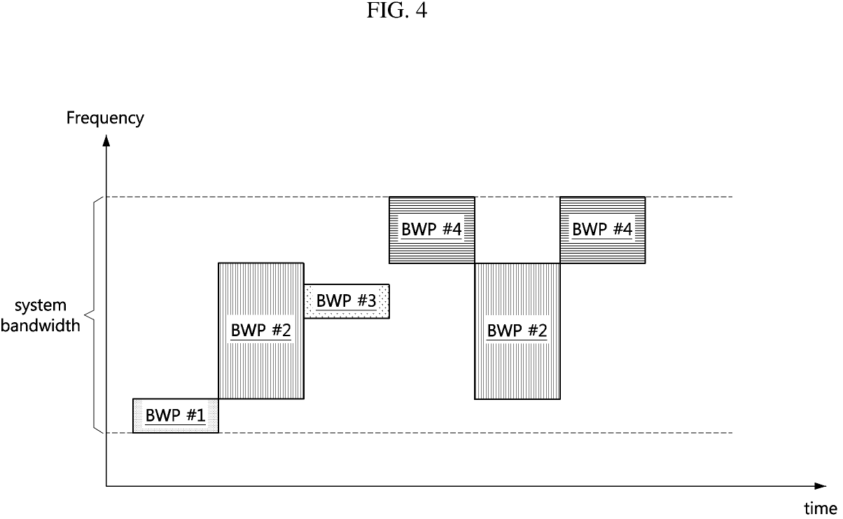

Each of remote radio transmission/reception nodes 320, 420-1, and 420-2 of FIGS. 3 and 4 and base stations 110-1, 110-2, 110-3, and 120-1 shown in FIGS. 1, 3, and 4 may support OFDM, OFDMA, SC-FDMA, or NOMA-based downlink transmission and uplink transmission. In a case where the remote radio transmission/reception nodes of FIGS. 3 and 4 and the plurality of base stations shown in FIGS. 1, 3, and 4 support beamforming functions by using antenna arrays through a transmission carrier of a mmWave band, each may provide services without interference between beams within a base station through a formed beam, and provide services for a plurality of terminals (or UEs) within one beam.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for transmitting and receiving an instant data packet in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the following description, the UPF (or, S-GW) may refer to a termination communication node of the core network that exchanges packets (e.g., control information, data) with the base station, and the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function (e.g., function of the Xhaul network, function of the core network) of a communication protocol depending on a radio access technology (RAT).

In order to perform a mobility support function and a radio resource management function, the base station may transmit a synchronization signal (e.g., a synchronization signal/physical broadcast channel (SS/PBCH) block) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the first base station 611 may transmit a synchronization signal and/or a reference signal so that the first terminal 621 located within its service area can search for itself to perform downlink synchronization maintenance, beam configuration, or link monitoring operations. The first terminal 621 connected to the first base station 611 (e.g., serving base station) may receive physical layer radio resource configuration information for connection configuration and radio resource management from the first base station 611. The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.

Configuration information of transmission frequency and frame format of base station

Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.

Frame format configuration information: configuration parameters of a mini-slot, slot, and subframe having a different symbol length according to a subcarrier spacing

Configuration information of downlink reference signal (e.g., channel state information-reference signal (CSI-RS), common reference signal (Common-RS), etc.)

Configuration parameters such as a transmission periodicity, transmission position, code sequence, or masking (or scrambling) sequence for a reference signal, which are commonly applied within the coverage of the base station (or beam).

Configuration information of uplink control signal

Configuration parameters such as a sounding reference signal (SRS), uplink beam sweeping (or beam monitoring) reference signal, uplink grant-free radio resources (or, preambles), etc.

Configuration information of physical downlink control channel (e.g., PDCCH)

Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of physical uplink control channel (e.g., PUCCH)
Scheduling request signal configuration information
Configuration information for a feedback (acknowledgement (ACK) or negative ACK (NACK)) transmission resource in a hybrid automatic repeat request (HARQ) procedure
Number of antenna ports, antenna array information, beam configuration or beam index mapping information for application of beamforming techniques
Configuration information of downlink signal and/or uplink signals (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering a handover procedure to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the following exemplary embodiments, ‘Resource-Configinformation’ may be a control message including one or more parameters of the physical layer radio resource configuration information. In addition, the ‘Resource-Configinformation’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Configinformation’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam the can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the exemplary embodiments, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

Each of the primary TCI state and the secondary TCI state may be assumed to be an active TCI state or a serving TCI state capable of transmitting or receiving data packets or control signaling even with restriction. In addition, the reserved (or candidate) TCI state may be assumed to be a deactivate TCI state or a configured TCI state in which data packets or control signaling cannot be transmitted or received while being a measurement or management target.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK , HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indices, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The reference value indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to -noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth. For example, BWPs may be configured as follows.

FIG. 4 is a conceptual diagram illustrating an exemplary embodiment of a method of configuring bandwidth parts (BWPs) in a communication system.

As shown in FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings may be applied to the BWPs #1 to #4. For example, the bandwidth of the BWP #1 may be 10 MHz, and the BWP #1 may have a 15 kHz subcarrier spacing. The bandwidth of the BWP #2 may be 40 MHz, and the BWP #2 may have a 15 kHz subcarrier spacing. The bandwidth of the BWP #3 may be 10 MHz, and the BWP #3 may have a 30 kHz subcarrier spacing. The bandwidth of the BWP #4 may be 20 MHz, and the BWP #4 may have a 60 kHz subcarrier spacing.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured reference value and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

The procedure for the terminal to access the base station (e.g., random access procedure) may be classified into an initial access procedure and a non-initial access procedure. The terminal operating in the RRC idle state may perform the initial access procedure. Alternatively, when there is no context information managed by the base station, the terminal operating in the RRC connected state may also perform the initial access procedure. The context information may include RRC context information, access stratum (AS) configuration information (e.g., AS context information), and the like. The context information may include one or more among RRC configuration information for the terminal, security configuration information for the terminal, PDCP information including a robust header compression (ROHC) state for the terminal, an identifier (e.g., cell-radio resource temporary identifier (C-RNTI)) for the terminal, and an identifier of the base station for which a connection configuration with the terminal has been completed.

The non-initial access procedure may refer to an access procedure performed by the terminal in addition to the initial access procedure. For example, the non-initial access procedure may be performed for an access request for transmission or reception data arrival at the terminal, connection resumption, resource allocation request, user (UE) request based information transmission request, link re-establishment request after a radio link failure (RLF), mobility function (e.g., handover function) support, secondary cell addition/change, active beam addition/change, or physical layer synchronization configuration.

The random access procedure may be performed based on the initial access procedure or the non-initial access procedure according to the operation state of the terminal.

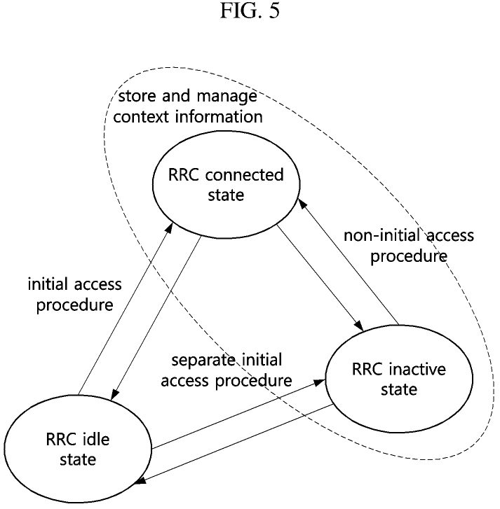

FIG. 5 is a conceptual diagram illustrating an exemplary embodiment of operation states of a terminal in a communication system.

As shown in FIG. 5, operation states of the terminal may be classified into an RRC connected state, an RRC inactive state, and an RRC idle state. When the terminal operates in the RRC connected state or the RRC inactive state, a radio access network (RAN) (e.g., a control function block of the RAN) and the base station may store and manage RRC connection configuration information and/or context information (e.g., RRC context information, AS context information) of the corresponding terminal.

The terminal operating in the RRC connected state may receive configuration information of physical layer control channels and/or reference signals required for maintaining connection configuration and transmission/reception of data from the base station. The reference signal may be a reference signal for demodulating the data. Alternatively, the reference signal may be a reference signal for channel quality measurement or beamforming. Therefore, the terminal operating in the RRC connected state may transmit and receive the data without delay.

When the terminal operates in the RRC inactive state, mobility management functions/operations identical or similar to mobility management functions/operations supported in the RRC idle state may be supported for the corresponding terminal. That is, when the terminal operates in the RRC inactive state, a data bearer for transmitting and receiving data may not be configured, and functions of the MAC layer may be deactivated. Accordingly, the terminal operating in the RRC inactive state may transition the operation state of the terminal from the RRC inactive state to the RRC connected state by performing the non-initial access procedure to transmit data. Alternatively, the terminal operating in the RRC inactive state may transmit data having a limited size, data having a limited quality of service, and/or data associated with a limited service.

When the terminal operates in the RRC idle state, there may be no connection configuration between the terminal and the base station, and the RRC connection configuration information and/or context information (e.g., RRC context information, AS context information) of the terminal may not be stored in the RAN (e.g., a control function block of the RAN) and the base station. In order to transition the operation state of the terminal from the RRC idle state to the RRC connected state, the terminal may perform the initial access procedure. Alternatively, when the initial access procedure is performed, the operation state of the terminal may transition from the RRC idle state to the RRC inactive state according to determination of the base station.

The terminal may transition from the RRC idle state to the RRC inactive state by performing the initial access procedure or a separate access procedure defined for the RRC inactive state. When a limited service is provided to the terminal, the operation state of the terminal may transition from the RRC idle state to the RRC inactive state. Alternatively, depending on capability of the terminal, the operation state of the terminal may transition from the RRC idle state to the RRC inactive state.

The base station and/or the control function block of the RAN may configure condition(s) for transitioning to the RRC inactive sate by considering one or more of the type, capability, and service (e.g., a service currently being provided and a service to be provided) of the terminal, and may control the operation for transitioning to the RRC inactive state based on the configured condition(s). When the base station allows the transition to the RRC inactive state or when the transition to the RRC inactive state is configured to be allowed, the operation state of the terminal may be transitioned from the RRC connected state or the RRC idle state to the RRC inactive state.

### Configuration and Conditions for Uplink Instant Message Transmission

Data having a small size and/or a signaling message having a small size (hereinafter referred to as ‘instant message (InstantMsg)’) may occur intermittently. That is, the instant message may refer to data or signaling information that is intermittently occurring with a size less than or equal to a predetermined size. When an instant message occurs in the base station, the base station may transmit the instant message to the terminal operating in the RRC idle state or the RRC inactive state. When an instant message occurs in the terminal, the terminal (e.g., the terminal operating in the RRC idle state or the RRC inactive state) may transmit the instant message to the base station. Here, the instant message may be transmitted through a paging procedure or a random access procedure.

The base station may transmit configuration information related to transmission of an instant message to the terminal. An uplink instant message occurring in the terminal may be transmitted by using a random access (RA) procedure or by using a pre-allocated uplink resource (PUR) or a configured grant (CG) resource preconfigured (or allocated) for instant message transmission. That is, the base station may configure a PUR for instant message transmission and deliver PUR configuration information to the terminal so that the terminal transmits an intermittently generated instant message.

In addition, the base station may deliver configuration information indicating whether instant message transmission using an RA procedure and/or a PUR (or CG resource) is allowed to the terminal as system information or a separate control message. Here, the separate control message may be a control message for configuring an RRC connection, a control message for releasing an RRC connection, or an RRC state transition control message (e.g., a control message for transition to the inactive state).

In a method of transmitting an uplink instant message, an RA procedure or a PUR may be used according to a connection state of the terminal and/or whether uplink physical layer synchronization (hereinafter, referred to as uplink synchronization) of the terminal is maintained. For example, a terminal maintaining uplink synchronization or a terminal in the connected state may transmit an instant message by using a PUR. On the other hand, a terminal in the inactive state or idle state, a terminal not maintaining uplink synchronization, a terminal in which a PUR is not configured, or a terminal in which a configured PUR is not valid may transmit an instant message by using an RA procedure. That is, a terminal in the inactive state or in the idle state in which a PUR is configured transmits an instant message by using a PUR. If a PUR condition for instant message transmission is not satisfied, the terminal may transmit an instant message by using an RA procedure.

In addition, in case of a PUR configured so that a terminal not maintaining uplink synchronization can use it for instant message transmission, a terminal in the inactive or idle state or a terminal not maintaining uplink synchronization may also use the PUR to transmit an instant message.

In addition, when uplink synchronization does not need to be maintained in a service coverage of the base station or transmission timing adjustment information of the terminal for maintaining uplink synchronization is not required, the base station may use system information or a separate control message to deliver one or more of the following information to the terminal. Here, the separate control message may be a control message for configuring an RRC connection, a control message for releasing an RRC connection, or an RRC state transition control message (e.g., a transition control message to the inactive state).
Information notifying that there is no need for an operation (or procedure) for maintaining uplink synchronization (or information indicating that uplink synchronization is valid)
Information notifying that instant message transmission using a PUR is allowed even when uplink synchronization is not maintained
Information notifying that a timer (e.g., timeAlignmentTimer) value for an operation for maintaining uplink synchronization is set to infinity

When one or more of the above information is delivered from the base station to the terminal, the terminal in the inactive state or idle state may transmit an instant message by using a PUR even when uplink synchronization is not maintained.

The information notifying that an operation (or procedure) for maintaining uplink synchronization is not required or that uplink synchronization (or timing advance (TA) synchronization) is valid may be configured based on the size of the base station service coverage, an uplink synchronization maintenance timer of the terminal (or a separate timer for determining whether instant message transmission using a PUR is allowed), a channel quality of a radio link, or position information of the terminal. For example, when compensation for a path delay is not required or uplink synchronization (or TA synchronization) is always valid according to the size of the base station service coverage, instant message transmission using a PUR may be allowed. For example, the uplink synchronization maintenance timer of the terminal is a separate timer for determining whether instant message transmission using a PUR is allowed, and when the uplink synchronization maintenance timer satisfies a reference condition (or value), instant message transmission using a PUR may be allowed. For example, if a distance between the terminal and the base station is determined to be a distance that does not require compensation for a path delay based on the position information of the terminal, instant message transmission using a PUR may be allowed regardless of whether or not TA is maintained or based on that the TA synchronization (or uplink synchronization) is valid. Here, the position information of the terminal may refer to a geographical position of the terminal or a relative position within the base station, which is estimated (or measured) by the terminal based on a position estimation algorithm, a GPS function, or a built-in sensor.

In addition, when a channel quality of a radio link between the serving or camped base station and the terminal satisfies a predefined reference condition (or value), it may be determined that a distance between the terminal and the base station is a distance that does not require compensation for a path delay or a distance that TA synchronization (or uplink synchronization) is valid. Therefore, in this case, instant message transmission using a PUR may be allowed. Here, the reference condition for the channel quality of the radio link may be a case in which one or more of the following parameters are satisfied.
When a channel quality of a radio link is higher than a reference value
When a channel quality remains above a reference value until a predetermined timer expires or for a predetermined time window
When a change or variation range of a channel quality of a radio link is equal to or higher than a reference value
When a change or variation range of a channel quality satisfies a reference condition until a predetermined timer expires or for a predetermined time window

Therefore, based on the size of the base station service coverage, the uplink synchronization maintenance timer of the terminal, the channel quality of the radio link, or the position information of the terminal, the base station may deliver to the terminal information indicating whether instant message transmission using a PUR is allowed regardless of whether uplink synchronization is maintained (or, TA is maintained) and/or information of a reference value (or threshold value) for determining whether instant message transmission using a PUR is possible through system information or an RRC control message.

The terminal may obtain the information indicating whether instant message transmission using a PUR is allowed and/or the information on a reference value (or threshold) for determining whether instant message transmission using a PUR is possible. Even when the terminal obtaining the above information is a terminal in the inactive state or idle state, or a terminal not maintaining uplink synchronization, the corresponding terminal may transmit an instant message by using a PUR when the reference condition is satisfied according to the obtained information.

In addition, when the terminal receives a message indicating transition from the RRC connected state to the RRC inactive state, a last reception time of uplink transmission timing adjustment information (TA information), a last reception time from the base station, or when a predetermined uplink synchronization maintenance timer (or a separate timer for determining whether instant message transmission using a PUR is allowed) from a last transmission time of the terminal does not expire, the terminal may determine that compensation for a path delay with the base station is not required or that TA synchronization (or UL synchronization) is valid, and may transmit an instant message by using a PUR.

In addition, the terminal may be controlled to transmit an instant message by using a PUR when satisfying one or more conditions or conditions selectively combined from among the size of the base station service coverage, the uplink synchronization maintenance timer of the terminal (or a separate timer for determining whether instant message transmission using a PUR is allowed), validity of a configured PUR, the channel quality of radio link, the size of the instant message, and/or the position information of the terminal.

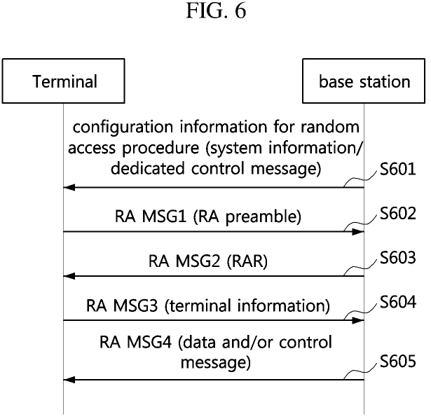

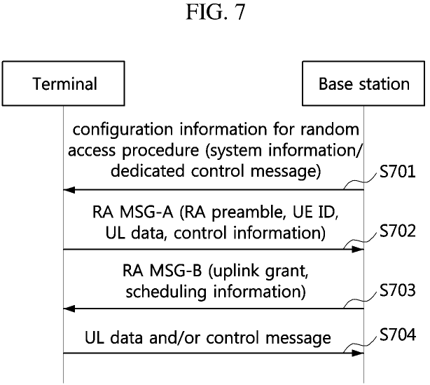

When a PUR configured for the terminal in the inactive state or idle state described above does not meet the PUR condition for instant message transmission or is not valid, the terminal may transmit an instant message by using an RA procedure described below. The RA procedure for instant message transmission may be performed as a radio access (or RA) procedure of a terminal consisting of four steps (4-step) or a radio access (or RA) procedure of a terminal consisting of two steps (2-step). Hereinafter, FIG. 6 is for describing an RA procedure composed of four steps (4-step), and FIG. 7 is for describing an RA procedure composed of two steps (2-step).

### Uplink Instant Message Transmission Method Using 4-step RA Procedure

FIG. 6 is a sequence chart illustrating a method of transmitting an instant message based on a 4-step random access procedure according to an exemplary embodiment of the present disclosure.

Referring to FIG. 6, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in four steps.

The base station may transmit system information and/or a control message including configuration information of a radio resource (e.g., uplink radio resource) for the random access procedure to the terminal (S601). The terminal may obtain the configuration information of the radio resource for the random access procedure by receiving the system information and/or control message from the base station. The system information may be common system information used for a plurality of base stations or base station-specific system information (e.g., cell-specific system information). The control message may be a dedicated control message. The control message may be a dedicated control message. Here, the dedicated control message may be a control message for configuring an RRC connection, a control message for releasing an RRC connection, or an RRC state transition control message (e.g., a control message for transition to the inactive state).

The system information may be system information commonly applied to a plurality of base stations or system information for each base station. The system information may be configured for each base station, for each beam group, or for each beam. The system information may include allocation information of the radio resource (e.g., uplink radio resource) for the random access procedure. The configuration information of the radio resource for the random access procedure may include one or more of transmission frequency information of the physical layer, system bandwidth information (or BWP configuration information), subcarrier spacing information, beam configuration information according to a beamforming technique (e.g., beam width, beam index), variable radio resource configuration information (e.g., radio resource reference value, offset) in the frequency and/or time domain, and inactive (or unused) radio resource region/interval information.

The terminal may transmit an RA message 1 (i.e., RA MSG1) including an RA preamble to the base station using the radio resource (e.g., physical random access channel (PRACH)) configured by the base station (S602). The message 1 including the RA preamble may be referred to as an ‘RA MSG1’ in the 4-step random access procedure, the RA preamble in the 4-step random access procedure may be referred to as a ‘4-step-RA preamble’.

The terminal may randomly select a code sequence (e.g., RA preamble, signature) defined for the random access procedure, and transmit the RA MSG1 including the selected code sequence. In a contention-based random access (CBRA) procedure, the terminal may randomly select the RA preamble. In a contention-free random access (CFRA) procedure, the base station may pre-allocate the RA preamble to the terminal. The pre-allocation of the RA preamble may mean that an index, masking information, etc. of the RA preamble for the RA MSG1 is allocated dedicatedly to the terminal. In this case, the terminal may perform the random access procedure (e.g., CFRA procedure) without contention with other terminals.

The base station may receive the RA MSG1 from the terminal, and may generate and transmit a response message for the RA MSG1 (S603). That is, in the step S603, the base station may generate or configure a response message for a random access request (or access attempt) and transmit it to the terminal. Hereinafter, the response message transmitted by the base station (or cell) in the step S603 is referred to as an RA MSG2. The response message transmitted by the base station in the step S603 may be transmitted in form of only a PDCCH (e.g., form of downlink control information (DCI)) for allocating an uplink radio resource, in form of only a PDCCH for the RA response, or through a physical downlink shared channel (PDSCH).

In the case that a PDCCH allocating an uplink radio resource is transmitted in the step S603, the corresponding DCI may include one or more among uplink resource allocation information (e.g., scheduling information), transmission timing adjustment information (e.g., a timing advance (TA) value, a TA command), transmission power adjustment information, backoff information, beam configuration information, TCI state information, configured scheduling (CS) state information, state transition information, PUCCH configuration information, an index of the RA MSG1 received in the step S602 (e.g., an index of the RA preamble), and uplink resource allocation information for transmission of an RA MSG3 in a step S604. Here, the beam configuration information may be information indicating activation or deactivation of a specific beam. The TCI state information may be information indicating activation or deactivation of a specific TCI state. The CS state information may be information indicating activation or deactivation of radio resources allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

The base station may transmit only a PDCCH for the RA response in the step S603. In this case, control information may be transmitted through a PDSCH. That is, the control information may include one or more among uplink resource allocation information (e.g., scheduling information), transmission timing adjustment information (e.g., TA value, TA command), transmission power adjustment information, backoff information, beam configuration information, TCI state information, CS state information, state transition information, PUCCH configuration information, the index of the message 1 (e.g., RA preamble) received in the step S602, and uplink resource allocation for transmission of an RA MSG3 in the step S604.

The base station may transmit scheduling information of the RA MSG2 to the terminal using a random access (RA)-RNTI. For example, a cyclic redundancy check (CRC) of the DCI including the scheduling information of the RA MSG2 may be scrambled by the RA-RNTI, and the corresponding DCI may be transmitted through the PDCCH. In addition, the base station may transmit the RA MSG2 using a cell-RNTI (C-RNTI). The base station may transmit the RA MSG2 on a PDSCH indicated by the scheduling information addressed by the scheduling identifier (e.g., RA-RNTI, C-RNTI).

The terminal may receive the RA MSG2 from the base station. The terminal may transmit an RA MSG3 (i.e., message 3) including its own information to the base station (S604). The terminal information may include one or more among the identifier of the terminal, capability, property, mobility status, location information, a reason for the radio access, size information of uplink data to be transmitted (e.g., buffer status report (BSR)), connection configuration request information, and uplink data. In addition, in the step S604, the terminal may transmit information requesting information required by the terminal to the base station.

When the RA MSG2 is received based on the DCI in the step S603, the terminal may perform an operation according to the information element(s) included in the PDCCH (or DCI). The information element(s) included in the PDCCH (or DCI) may include one or more among transition request information of the operation state of the terminal, request information for maintaining the operation state of the terminal, information indicating activation or deactivation of a beam, information indicating activation or deactivation of a TCI state, information indicating activation or deactivation of a CS state. In this case, the random access procedure may be terminated without performing the step S604.

If the RA MSG2 is received based on the DCI, and an uplink radio resource for the RA MSG3 is not allocated in the step S603, the terminal may wait until allocation information of the uplink radio resource for the RA MSG3 is received. When the allocation information of the uplink radio resource for the RA MSG3 is received before a preconfigured timer expires, the terminal may transmit the RA MSG3 to the base station using the uplink radio resource. On the other hand, when the allocation information of the uplink radio resource for the RA MSG3 is not received until the preconfigured timer expires, the terminal may perform the random access procedure again. That is, the terminal may perform again from the step S602.

In a step S605, the base station may transmit downlink information requested by the terminal. Alternatively, the base station may transmit downlink data or a control message to the terminal. In the step S605, the base station may transmit the terminal identifier received from the terminal (e.g., the terminal identifier received in the step S604) to the terminal. A message 4 transmitted by the base station in the step S605 may be referred to as an ‘RA MSG4’.

The base station may transmit resource allocation information (e.g., scheduling information) for transmission of the RA MSG3 to the terminal using the RA MSG2. The scheduling information may include one or more among the identifier of the base station transmitting the scheduling information, beam index, identifier for identifying the scheduling information, radio resource allocation information, MCS information, and resource allocation information for transmission of feedback information (e.g., ACK or NACK) indicating whether the scheduling information is received. The radio resource allocation information may include frequency domain resource allocation information (e.g., transmission band information, subcarrier allocation information) and/or time domain resource allocation information (e.g., frame index, subframe index, slot index, symbol index, transmission period, transmission timing).

In the random access procedure shown in FIG. 6, the RA MSG3 may include one or more of the following information elements.
Capability of the terminal
Properties of the terminal
Mobility state of the terminal
Location information of the terminal
Reason for attempting the access procedure (e.g., random access procedure)

The reason for attempting the access procedure may be a transmission request of system information according to a request of the terminal, transmission request of downlink data according to update of a firmware or essential software of the terminal, or uplink resource allocation request. The information indicating the reason for attempting the access procedure may be information capable of distinguishing the reason for performing the access procedure. The information capable of distinguishing the reason for performing the access procedure may be as follows.
Uplink resource allocation information
Handover request information or measurement result information
Terminal operation state transition (or, change) request information
Resumption information of a radio channel
Re-establishment information of a radio channel
Information related to beam sweeping, beam reconfiguration, or beam change for beam forming
Information related to physical channel synchronization acquisition
Update information of location information
Mobility state or buffer status report

Using the 4-step RA procedure of FIG. 6, the terminal in the idle state or in the inactive state may transmit a data packet or a signaling message of an intermittently-generated instant message (e.g., a control message of the MAC layer or the RRC layer) (e.g., instant message).

The terminal (e.g., the terminal operating in the RRC idle state or the RRC inactive state) may transmit the data packet of the instant message and/or the signaling message by using the 4-step random access procedure shown in FIG. 6. The signaling message of the instant message may be a MAC signaling message (e.g., a control message of the MAC layer) or an RRC signaling message (e.g., a control message of the RRC layer).

For transmission of the instant message, the terminal may transmit at least one of the following information to the base station by using the RA MSG3 and/or a control message (e.g., MAC CE or RRC message) first transmitted after the RA MSG3.
Identifier (ID) of the terminal
Information informing a transmission request (or, transmission) of an uplink instant message
Information indicating the size of the uplink data (e.g., length indicator (LI)). The information indicating the size of the uplink data may indicate the size of the MAC PDU or RRC message or the number of the MAC PDUs and RRC messages.
Information indicating an uplink signaling message (e.g., uplink bearer message) and/or the size of the uplink signaling message (e.g., LI). The information indicating the size of the uplink signaling message may indicate the size of the MAC PDU or RRC message or the number of the MAC PDUs or RRC messages.
Indicator information indicating a range of the size of the uplink data and/or the size of the uplink signaling message
Logical channel identifier (e.g., LCID) of an uplink data bearer or an uplink signaling bearer
Uplink buffer size information (e.g., BSR)
Information indicating whether the size of the instant message meets a preconfigured condition
Control message for connection configuration request
Information requesting uplink resource allocation
Measurement result of a radio channel
Information on a desired terminal state after completion of transmission of the instant message

The information indicating whether the size of the uplink instant message satisfies a preconfigured condition may be information indicating whether the size of the instant message to be transmitted by the terminal is less than or equal to a preconfigured condition (or threshold). The base station may determine a size and/or MCS level of an uplink resource allocated to the terminal based on the information indicating whether the size of the uplink instant message satisfies a preconfigured condition. In addition, the reference condition (or threshold) may be information indicating whether one-time transmission of the instant message (i.e., one-shot transmission) is allowed, and/or a reference condition (or threshold) parameter for the size of the instant message (or the number of messages) allowed to be transmitted through segmented transmission. Here, the segmented transmission refers to a case in which one or more instant messages are transmitted by being segmented at different transmission times, or uplink radio resources configured or scheduled for transmission of the instance message are configured to be temporally different. Here, the reference condition (or threshold) may be preconfigured in the communication system according to a class of the terminal, capability of the terminal, type of the bearer, and/or type (e.g., coverage) of the base station. Alternatively, the reference condition (or threshold) may be a configuration or indication parameter according to the class of the terminal, capability of the terminal, type of the bearer, and/or type (e.g., coverage) of the base station. The base station may deliver the reference condition (or threshold) to the terminal by using system information, an RRC message, a MAC message (e.g., MAC CE), and/or a PHY message (e.g., DCI).

For transmission of an uplink instant message, when the terminal delivers the above-described information indicating the size of the uplink data and/or signaling message (e.g., the size of the MAC PDU or RRC message or the number of the MAC PDUs or RRC messages, etc.) and/or information indicating a range of the size of the uplink data and/or uplink signaling message, information indicating whether the instant message is transmitted as segmented (or information indicating whether the instant message is transmitted as one-time transmission) may be delivered together by using the RA MSG3 or a control message (e.g., MAC CE or RRC message) transmitted after the RA MSG3. Depending on whether the instant message is transmitted as segmented, the terminal may transmit a separate control message (e.g., MAC layer and/or RRC layer control message) in addition to the instant message. For example, when the instant message is transmitted as segmented (e.g., when two or more instant messages are transmitted through different time and/or frequency uplink radio resources), the terminal may deliver one or more among uplink radio resource request information for transmission of segmented instant messages and/or the size of the uplink instant message (e.g., the size of the MAC PDU or RRC message, etc.), the number of messages for the uplink instant message (e.g., the number of the MAC PDUs or RRC messages, etc.), uplink buffer size information (e.g., BSR), a control message for connection configuration request, indication information indicating whether the size of the uplink instant message satisfies a preconfigured condition, information such as a radio channel measurement result, or a desired operation state of the terminal after completion of the instant message transmission. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined (or confirmed) that segmented transmission is applied based on the control information received from the terminal, the base station may allocate uplink radio resources and/or PURs for the segmented transmission of the instant message to the terminal. In this case, frequency-domain configuration information of uplink radio resources and/or PURs for transmission of the instant message and time-domain configuration information such as a transmission start time and/or transmission end time, an instant message transmission period (or window, timer, counter), or a transmission periodicity within the transmission period may be delivered to the terminal. Here, the instant message transmission period (or window, timer, counter) may be a period in which radio link management for instant message transmission and resource allocation (or scheduling) for instant message transmission are valid for the corresponding terminal (or group), or a timer for determining whether the instant message has been successfully transmitted. The time-domain configuration information may be configured in units of radio frames, subframes, slots, mini-slots, or symbols.

By using the uplink radio resource(s) for instant message transmission allocated from the base station, the terminal may transmit the instant message by segmenting it or transmit the instant message as one-time transmission. After transmitting the instant message, the terminal may release the corresponding uplink radio resource(s) according to configuration of the base station. In the case of one-time transmission of the instant message, the terminal may release the corresponding uplink radio resource. In addition, in the transmission step of the last segment of the instant message or the one-time transmission step of the instance message, the terminal may selectively transmit control information for requesting uplink radio resource configuration together. The terminal may transmit an uplink radio resource configuration/allocation request in form of a control field of uplink physical layer control information, a MAC control message, or an RRC control message. Here, the MAC control message may be configured in form of an LCID or MAC subheader indicating an uplink radio resource request, or may be configured in form of a MAC (sub)PDU including one or more of the above-described control information for instant message transmission.

In addition, from the RA MSG3 or the uplink control message (e.g., MAC CE or RRC message) after the RA MSG3 transmitted by the terminal for the transmission of the uplink instant message, the base station may obtain information such as information on whether the instant message is transmitted as being segmented (or whether the instant message transmitted as one-time transmission), the size of the uplink instant message (e.g., the size of the MAC PDU or RRC message, etc.), and/or the number of messages for the uplink instant message. The base station obtaining the information may transmit allocation (or scheduling) information for uplink radio resources for transmission of two or more segmented instant messages to the terminal rather than one-time transmission (or one-shot transmission). In this case, the allocation (or scheduling) information for uplink radio resources after the RA MSG3 may be transmitted in form of uplink grant information in an RA MSG 4 or a separate MAC (sub)header and/or MAC CE, or may be transmitted in form of a physical layer control channel (PDCCH or DCI). When the allocation (or scheduling) information for uplink radio resources is transmitted through a physical layer control channel (PDCCH or DCI), the allocation (or scheduling) information for uplink radio resources may be transmitted to the terminal through resources of a CORESET configured for uplink instant message transmission.

As a method of classifying random access radio resource groups for instant message transmission, a method of classifying and configuring indices of random access occasions (ROs) and/or RA preambles may be considered. That is, in the radio resource configuration of random access occasions, the uplink radio resource(s) used for the RA procedure not for instant message transmission, and the uplink radio resource(s) used for the RA procedure for instant message transmission may be configured as being separated. In addition, indices of the RA preambles for instant message transmission may be configured as being separated. The base station may configure one or more RA preamble (RA MSG1) resource groups selectable according to the size of the uplink instant message and/or a channel quality of a radio link (path loss, RSRP, RSRQ, etc.). That the random access radio resources for instant message transmission are configured differently may mean that the terminal transmit the RA preambles or RA payloads by configuring different positions or indices of radio resources in the time domain or frequency domain, indices of RA preambles, transmission timings, or offset values.

When the RA MSG3 of the step S604 includes the above-described terminal identifier, uplink data, or control signaling information, control fields for indicating the property or the length of the uplink data and control signaling information, or whether the corresponding control information is included may be configured in form of a MAC subheader, a MAC header, or a logical channel identifier (e.g., LCID), or a MAC control element (CE).

Using the RA procedure of FIG. 6 described above, the terminal may perform a procedure for transmitting an intermittently occurring uplink instant message. When transmission of an uplink instant message is required, the terminal in the inactive state or the idle state may trigger the RA procedure (or operation) according to FIG. 6. That is, if the condition(s) preconfigured for the intermittent UL instant message transmission is satisfied, the terminal may perform the step S602 by selecting an RA MSG1 satisfying the above-described condition.

In this case, the base station may separately configure the RO configuration parameter(s) and/or the RA MSG1 for transmission of the intermittent uplink instant message. The base station may separately configure the RO configuration parameter(s) and/or RA MSG1 according to the size or type (or form) of the uplink message to be transmitted by the terminal and/or the channel quality of the radio link. Upon receiving the RA MSG1 for instant message transmission, the base station may transmit the RA response message by performing the step S603 of FIG. 6. The RA response message may include allocation information for an uplink radio resource for RA MSG3 transmission. The terminal may transmit the generated uplink instant message by using the uplink radio resource allocated for the RA MSG3. The RA response message for the RA MSG1 transmitted by the terminal for instant message transmission and an RA response message (RA MSG2) for an RA procedure for other purposes may differ in formats (or configuration of parameters). That is, the response message (RA MSG2) for the RA MSG1 transmitted by the terminal for instant message transmission may include uplink radio resource allocation information for instant message transmission.

In this case, the MAC subheader for the RA MSG2 may include field parameter (or indicator) information indicating that the corresponding RA MSG2 is the RA MSG2 according to the 4-step RA procedure for instant message transmission. For example, a corresponding indicator (or bit) set to ‘1’ may indicate that the RA MSG2 includes uplink radio resource allocation information for instant message transmission, or that the RA MSG2 is the RA MSG2 of the 4-step RA procedure performed for instant message transmission. The corresponding indicator (or bit) set to ‘0’ may indicate that the RA MSG2 does not include uplink radio resource allocation information for instant message transmission, or that the RA MSG2 is an RA MSG2 of a 4-step RA procedure performed for a purpose other than instant message transmission.

In addition, the RA MSG2 of the 4-step RA procedure performed for instant message transmission may include the terminal identifier for instant message transmission, transmission power adjustment information (e.g., TPC), PUCCH resource indicator, transmission timing adjustment information (e.g., timing advance command), MCS index, and/or uplink radio resource allocation information (or PUSCH resource indicator) for instant message transmission. Here, the terminal identifier for instant message transmission may be an identifier assigned to the terminal to identify the terminal in the inactive state, I-RNTI of the 3GPP NR system, a terminal identifier in an RRC resume request message (e.g., resumeIdentity, I-RNTI, or ShortI-RNTI of the 3GPP NR system, etc.).

The base station may estimate the size or type (or form) of the uplink message to be transmitted by the terminal and/or the level of the channel quality of the radio link based on the RA MSG1 received from the terminal, and transmit allocation information of an uplink radio resource for transmission of the RA MSG3 to the terminal as an RA response message. That is, the base station may determine the size and/or MCS level of the uplink radio resource for transmission of the RA MSG3 in consideration of the size or type (or form) of the uplink message of the terminal and/or the radio link channel quality indicated by the RA MSG1 received from the terminal, and transmit the allocation information of the corresponding uplink radio resource to the terminal by using the RA response message.

As another method, the base station may transmit uplink scheduling information for transmission of an uplink instant message to the terminal within a preconfigured time period (e.g., a time window (or period) preconfigured when the step S602 is performed). The uplink scheduling information may be transmitted on a physical layer control channel (PDCCH). In this case, a scheduling identifier may be RA-RNTI or RTNI for instant message transmission (e.g., IM-RNTI). The IM-RNTI may be used when transmitting scheduling information for transmission of the uplink instant message. Accordingly, the terminal may obtain the uplink scheduling information from the RA MSG2 received by using the RA-RNTI and/or a PDCCH or PDSCH received by using the IM-RNTI. That is, the uplink scheduling information for instant message transmission may be delivered to the terminal using a PDCCH or PDSCH resource. Accordingly, the terminal may transmit the uplink instant message occurring in the terminal by using the uplink radio resource allocated based on the corresponding uplink scheduling information.

When the RA MSG1 for transmission of the uplink instant message is not separately configured, the terminal transmitting the RA MSG1 may receive the RA response message of the step S603 according to the procedure of FIG. 6. Thereafter, the terminal may transmit the RA MSG3 including the above-described control information for instant message transmission to the base station.

The base station may determine whether to transition the state of the terminal based on the above-described BSR information, information indicating the size of the uplink instant message, information indicating whether the instant message satisfies a reference condition, or information on the desired state of the terminal after instant message transmission is completed, which is received through the RA MSG3 of the step S604 or the control message (e.g., MAC layer or RRC control message, etc.) after completion of the RA procedure of FIG. 6. For example, if the terminal satisfies a reference condition for transmitting uplink data in the inactive or idle state without transitioning to the connected state, the base station may control the terminal to transmit the instant message in the inactive state or control the terminal to transition to the inactive state or idle state after the instant message is transmitted.

When the terminal requests transmission of a message larger than a reference condition (or threshold), the base station may control the terminal to transition to the connected state and transmit the corresponding message. In addition, when determining that it is necessary, the base station may indicate or control the terminal performing the RA random access procedure to transition to the connected state or inactive state to perform uplink transmission or downlink reception operation by using the response message or a separate control message.

The base station may transmit the scheduling information of the uplink radio resource to the terminal in the step S604 or after the step S604 so that the terminal transmits the uplink instant message. The uplink scheduling information may be transmitted on a PDCCH or PDSCH. In this case, a scheduling identifier may be a C-RNTI included in the RA response message of the step S603 or an RTNI for instant message transmission (e.g., IM-RNTI). Here, the IM-RNTI means a scheduling identifier assigned to the terminal (or terminal group) for instant message transmission. In addition, one of scheduling identifiers uniquely assigned to a specific terminal (e.g., C-RNTI, SPS-RNTI, CS-RNTI, TPC RNTI, INT-RNTI, SFI-RNTI) may be used as the RNTI for instant message transmission (i.e., IM -RNTI), or a group scheduling identifier (or multicast scheduling identifier) assigned to a terminal group may be configured and used as the RNTI for instant message transmission (i.e., IM-RNTI). That is, the corresponding group scheduling identifier may be configured as the scheduling identifier for instant message transmission while performing a role of a scheduling identifier assigned to the terminal (or terminal group).

In the RA procedure for instant message transmission, when the base station transmits the RA response message using the RNTI for instant message transmission or transmits the scheduling information for instant message transmission, the corresponding PDCCH (or DCI) may include uplink radio resource allocation information for instant message transmission.

The terminal may transmit the uplink instant message by using the uplink radio resource allocated based on the corresponding uplink scheduling information. In addition, when the control information transmitted by the terminal in the step S604 is transmitted through a MAC layer message, whether the corresponding control information exists and/or values (or, ranges of configuration parameters) of the control information may be delivered in form of a MAC (sub)header or MAC (sub)PDU. For this, a separate logical channel identifier (LCID) may be configured.

### Uplink Instant Message Transmission Method Using 2-step RA Procedure

FIG. 7 is a sequence chart illustrating a method of transmitting an instant message based on a 2-step random access procedure according to an exemplary embodiment of the present disclosure.

Referring to FIG. 7, a communication system may include a base station, a terminal, and the like. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same or similar to the communication node shown in FIG. 2. A random access procedure may be performed in two steps.

The base station may transmit system information and/or a control message including configuration information of a radio resource (e.g., uplink radio resource) for the random access procedure to the terminal (S701). The terminal may obtain the configuration information of the radio resource for the random access procedure by receiving the system information and/or the control message from the base station. Here, the control message may be a dedicated control message. The system information and/or dedicated control message may be the same as or similar to the system information and/or dedicated control message in the step S601 shown in FIG. 6.

The terminal may transmit an RA MSG-A to the base station using the radio resource configured by the base station (S702). The RA MSG-A may include an RA preamble and a terminal identifier (e.g., UE ID, C-RNTI). In addition, the RA MSG-A may further include uplink data and/or control information. In the 2-step random access procedure, a message 1 may be referred to as the ‘RA MSG-A’ or ‘MSG-A’, and the RA MSG-A may be distinguished from the RA MSG1 in the 4-step random access procedure.

The RA MSG-A may include an RA preamble and an RA payload. In the 2-step random access procedure, the RA preamble may be referred to as a ‘2-step-RA preamble’, and in the 2-step random access procedure, the RA payload may be referred to as a ‘2-step-RA payload’. The RA preamble of the RA MSG-A may be selected by the MAC layer of the terminal. The RA payload of the RA-MSG-A may be generated by the MAC layer or the RRC layer. The RA preamble selected by the MAC layer of the terminal and the RA payload generated by the MAC layer or RRC layer of the terminal may be delivered to the physical layer. The RA payload of the RA MSG-A may include one or more among the terminal identifier (e.g., UE ID, C-RNTI), uplink data, and control information. The base station may configure the following random access parameters or configuration information selectively applied according to the size of the uplink instant message and/or the channel quality of the radio link (path loss, RSRP, or RSRQ, etc.), and the terminal may obtain the information in the step S701.
Group configuration information of one or more MSG-A RA preamble resources according to the size of the instant message and/or the channel quality of the radio link, and/or
Group configuration information (e.g., MCS configuration list or range) of one or more MCS levels to be applied to the RA payload according to the size of the instant message and/or the channel quality of the radio link

Depending on the size of the uplink instant message and/or the channel quality of the radio link, the terminal may select the MSG-A RA preamble and/or an MCS level to be applied to the MSG-A RA payload satisfying the condition. When the MSG-A RA preamble resources and MCSs to be applied to the MSG-A RA payload according to the size of the instant message and/or the channel quality of the radio link have a mapping or association relationship, if the terminal select the MSG-A RA preamble satisfying the condition according to the size of the instant message and/or the channel quality of the radio link, the MCS level to be applied to the MSG-A RA payload may be determined according to the selected MSG-A RA preamble.

Information on the selected RA preamble and the generated RA payload may be delivered to the physical layer, and the RA MSG-A including the selected RA preamble and the generated RA payload may be transmitted to the base station (S702). The RA payload of MSG-A may include a terminal identifier (e.g., UE ID or C-RNTI, etc.), uplink data (or instant message packet), a logical channel identifier (LCI) for identifying a bearer for instant message transmission (data radio bearer (DRB) or signaling radio (SRB) bearer), or control signaling information. Here, the control signaling information may include a BSR, measurement result information (e.g., quality information), BFR request information, RLF report information, request information of RRC connection setup, request information of RRC connection re-establishment, resume request information, and transmission request information of system information. When the CBRA procedure or the CFRA procedure is performed, the RA payload may include the terminal identifier. The uplink radio resource for transmission of the RA preamble may be configured independently of the uplink radio resource for transmission of the RA payload.

For example, the radio resources configured (or allocated) for the radio access procedure may be non-contiguous in the time domain or frequency domain. Alternatively, the radio resources configured (or allocated) for the radio access procedure may be contiguous in the time domain or frequency domain. The radio resources for the radio access procedure may be radio resources configured (or allocated) in different schemes. Alternatively, the radio resources for the radio access procedure may be radio resources defined by different physical layer channels.

The expression that the radio resources for the radio access procedure are different may mean that one or more among the positions of the radio resources in the time domain or frequency domain, indices of the radio resources, indices of the RA preambles, transmission timings, and offsets are configured differently. The RA preamble or RA payload may be transmitted using different radio resources. For example, the RA preamble may be transmitted on a PRACH, and the RA payload may be transmitted on a physical uplink shared channel (PUSCH).

In order to configure the transmission resource for the RA preamble of the RA MSG-A differently from the transmission resource for the RA payload of the RA MSG-A, the uplink radio resource for transmission of the RA payload of the RA MSG-A (e.g., PUSCH configured for transmission of the RA payload of the RA MSG-A) may be configured to correspond to the RA preamble of the RA MSG-A. That is, a mapping relationship between the uplink radio resource for transmitting the RA preamble of the RA MSG-A and the uplink radio resource for transmitting the RA payload of the RA MSG-A may be configured.

For example, the transmission resource of the RA preamble may be mapped one-to-one with the transmission resource of the RA payload. In this case, one PRACH may be mapped to one PUSCH. Alternatively, a plurality of transmission resources of the RA preamble may be mapped to one transmission resource of the RA payload. In this case, a plurality of PRACHs may be mapped to one PUSCH. Alternatively, one transmission resource of the RA preamble may be mapped to a plurality of transmission resources of the RA payload. In this case, one PRACH may be mapped to a plurality of PUSCHs. In order to improve the reception quality of the RA payload, the RA payload may be repeatedly transmitted. The uplink radio resources for the repetitive transmission of the RA payload may be configured, and the corresponding uplink radio resources may be mapped to the transmission resources of the RA preamble.

For example, when the transmission resource of the RA MSG-A is preconfigured or when the RA preamble of the RA MSG-A is transmitted through a preconfigured region (or group), the base station may configure radio resources for the repetitive transmissions of the RA payload of the RA MSG-A. Therefore, when a coverage expansion function is applied or when a preconfigured reference condition is satisfied, the terminal may select RA preamble resources or RA preamble index for the repetitive transmissions of the RA payload, and may repeatedly transmit the RA payload based on the selected resource or index. The terminal may repeatedly transmit the RA payload using uplink radio resources mapped to the RA preamble index. The uplink radio resources (e.g., repeated radio resources) for transmission of the RA payload may be configured within a preconfigured period in the frequency domain or time domain. Information on a mapping relationship of the uplink radio resources for transmission of the RA MSG-A may be transmitted to the terminal through system information and/or an RRC message.

When the 2-step random access procedure is performed in a non-contention scheme, the transmission resources of the RA preamble and/or the RA payload of the RA MSG-A may be allocated dedicatedly to the terminal. In the CFRA procedure, resource information of the RA preamble configured dedicatedly for the terminal may include an SS/PBCH resource list, a CSI-RS resource list, an SS/PBCH index, a CSI-RS index, an RA preamble index, and the like. The transmission resource of the RA payload of the RA MSG-A may be determined based on the mapping relationship (e.g., one-to-one mapping relationship or many-to-one mapping relationship) between the transmission resource of the RA preamble and the transmission resource of the RA payload. In the CFRA procedure (e.g., 2-step CFRA procedure), the resource information of the RA payload configured dedicatedly for the terminal may include allocation information of an uplink radio resource, beam configuration information, MCS information, etc. for transmission of the RA payload.

In the 2-step RA procedure, the transmission resource of the RA preamble may be contiguous with the transmission resource of the RA payload in the time domain. Alternatively, the transmission resource of the RA preamble and the transmission resource of the RA payload may be allocated within a time window. The terminal performing the 2-step RA procedure may transmit the RA payload using the transmission resource of the RA payload, that is contiguous with the transmission resource of the RA preamble. Alternatively, the terminal may transmit the RA payload using an RA payload transmission resource within a preconfigured time window.

Alternatively, parameter(s) for allocation of the transmission resource of the RA preamble and the transmission resource of the RA payload may include a frequency offset and/or a time offset. Accordingly, the terminal may transmit the RA payload using the radio resource for the RA payload mapped to the RA preamble. Alternatively, the terminal may randomly select one or more radio resources among radio resources configured for transmission of the RA payload, and may transmit the RA payload using the selected radio resource(s).

The RA payload of the RA MSG-A transmitted in the step 702 may be configured to be the same or similar to the RA MSG3 transmitted in the step S604 shown in FIG. 6. For example, the RA payload of the RA MSG-A may include one or more among the identifier, capability, property, mobility state, and position information of the terminal, a cause for attempting the access procedure, request information of beam failure recovery, measurement result on a base station (or cell) in the CA environment, request information of activation/deactivation of the CA, BWP switching request information, BWP deactivation/activation request information, uplink data (e.g., instant message packet), size of the uplink data (e.g., instant message packet), uplink buffer size information (e.g., BSR), control message for requesting connection configuration, information indicating whether the size of the uplink instant message satisfies a preconfigured condition, request information of uplink resource allocation, and a measurement result of a radio channel. The control information for transmission of the uplink instant message included in the RA MSG3 shown in FIG. 6 may be included in the RA payload of the RA MSG-A in FIG. 7. That is, the terminal may transmit the RA payload including control information for transmission of the uplink instant message to the base station. That is, for transmission of the uplink instant message, the terminal may transmit information indicating whether the instant message is transmitted as segmented (or whether the instant message is transmitted as one-time transmission) together by using the MSG-A RA payload. Depending on whether the instant message is transmitted as segmented, the terminal may transmit a separate control message (e.g., MAC layer and/or RRC layer control message) in addition to the instant message. For example, when the instant message is transmitted as segmented (e.g., when two or more instant messages are transmitted through different time and/or frequency uplink radio resources), the terminal may deliver one or more among uplink radio resource request information for the transmission of segmented instant messages and/or the size of the uplink instant message (e.g., the size of the MAC PDU or RRC message, etc.), the number of messages for the uplink instant message (e.g., the number of the MAC PDUs or RRC messages, etc.), uplink buffer size information (e.g., BSR), a control message for connection configuration request, indication information indicating whether the size of the uplink instant message satisfies a preconfigured condition, information such as a radio channel measurement result, or a desired operation state of the terminal after completion of the instant message transmission. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined (or confirmed) that segmented transmission is applied based on the control information received from the terminal, the base station may allocate uplink radio resources and/or PURs for the segmented transmission of the instant message to the terminal. In this case, frequency-domain configuration information of uplink radio resources and/or PURs for instant message transmission and time-domain configuration information such as a transmission start time and/or transmission end time, an instant message transmission period (or window, timer, counter), or a transmission periodicity within the transmission period may be delivered to the terminal. Here, the instant message transmission period (or window, timer, counter) may be a period in which radio link management for instant message transmission and resource allocation (or scheduling) for instant message transmission are valid for the corresponding terminal (or group), or a timer for determining whether the instant message has been successfully transmitted. The time-domain configuration information may be configured in units of radio frames, subframes, slots, minislots, or symbols.

By using the uplink radio resource(s) for instant message transmission allocated from the base station, the terminal may transmit the instant message by segmenting it or transmit the instant message as one-time transmission. After transmitting the instant message, the terminal may release the corresponding uplink radio resource(s) according to configuration of the base station. In the case of one-time transmission of the instant message, the terminal may release the corresponding uplink radio resource. In addition, in the transmission step of the last segment of the instant message or the one-time transmission step of the instance message, the terminal may selectively transmit control information for requesting uplink radio resource configuration together. The terminal may transmit an uplink radio resource configuration/allocation request in form of a control field of uplink physical layer control information, a MAC control message, or an RRC control message. Here, the MAC control message may be configured in form of an LCID or MAC subheader indicating an uplink radio resource request, or may be configured in form of a MAC (sub)PDU including one or more of the above-described control information for instant message transmission.

When the terminal identifier, uplink data, or control signaling information is transmitted in the step S702 through the radio resource for transmission of the MSG-A RA payload together with the RA preamble, control fields indicating the property or length of the corresponding uplink data and the corresponding control signaling information or information whether the corresponding control information is included may be configured in form of a MAC header, logical channel identifier (e.g., LCID), or MAC CE.

In the step S702, for transmission timing adjustment (e.g., timing advance (TA)) or transmission power control of the terminal, the terminal may transmit the RA payload of the MSG-A by inserting a preamble, pilot symbol, or reference signal (e.g., RS) in a first symbol or some symbols constituting the RA payload of the MSG-A.

The base station receiving the identifier of the terminal and uplink data or control signaling information transmitted by the terminal through the MSG-A of the step S702 may generate and transmit an RA response message (hereinafter, RA MSG-B) (S703). The RA MSG-B may include a backoff indicator (BI), uplink radio resource allocation information, information indicating the RA preamble of the received RA MSG-A, transmission timing adjustment information (TA) of the terminal, scheduling identifier (C-RNTI or Temporary C-RNTI, etc.), and/or a terminal identifier (hereinafter referred to as a contention resolution ID (CRID)) for contention resolution.

If the MSG-B is scheduled by the C-RNTI allocated to the terminal in the 2-step RA procedure or a CRID transmitted through the MSG-A is included in the MSG-B, the base station may determine that contention has been resolved. In particular, when the base station transmits scheduling information of a PDSCH including the MSG-B (or RA response message for the MSG-A) by using the C-RNTI, if the terminal receives the MSG-B (i.e., RA response) including the TA information and uplink grant information within the RA response window (or before a related timer expires), the terminal may determine that contention resolution for the MSG-A transmitted by the terminal has been completed. In this case, in order to clarify that the MSG-B scheduled by the C-RNTI is a response to the 2-step RA procedure according to the MSG-A transmitted by the terminal, a field (or bit) in a PDCCH (e.g., DCI or UCI) may be used to indicate that the MSG-B scheduled by the corresponding PDCCH is an RAR. Alternatively, information of a field of a MAC subheader or a logical channel identifier (LCID) for transmission of a MAC CE for the RAR may be used to indicate that the MSG-B scheduled by the C-RNTI is a response to the 2-step RA procedure according to the MSG-A transmitted by the terminal. Here, in the 4-step RA procedure, the RA response window may start when the transmission of the RA MSG1 is completed, and in the 2-step RA procedure, the RA response window may start when the transmission of the RA payload of the MSG-A is completed. Therefore, if the terminal does not receive the MSG-B (i.e., RA response) including TA information or uplink grant information scheduled by the C-RNTI within the RA response window (or before the related timer expires), it may be determined that the contention resolution for the 2-step RA procedure according to the MSG-A transmitted by the terminal has failed. If the MSG-B scheduled by the C-RNTI is transmitted in response to the 2-step RA procedure according to the MSG-A transmitted by the terminal, a PDCCH (e.g., DCI or UCI) including an indicator indicating that scheduling information for the RA response to the MSG-A is included along with TA information may be transmitted.

The RA MSG-B may be generated in form of a MAC control message (e.g., MAC CE) of the MAC layer of the base station and/or in form of an RRC control message of the RRC layer of the base station. When the RA MSG-B is generated in form of a MAC CE, the RRC layer, which received information on the received MSG-A, may deliver control parameters to be included in the RA MSG-B to the MAC layer, and the MAC layer may generate (or, configure) the RA MSG-B in form of a MAC CE. In the step S703, the base station may transmit the identifier of the terminal received through the RA payload of the MSG-A by including it in the RA MSG-B.

When the RA preamble of the MSG-A is dedicatedly allocated to the terminal, or the radio resources for transmission of the RA preamble and the RA payload of the MSG-A have a predetermined mapping relationship, the RA response message of the step S703 may not include information on the index of the RA preamble transmitted by the terminal.

When the RA preamble of the MSG-A is dedicatedly allocated to the terminal, or when the RA payload including the scheduling identifier (e.g., C-RNTI) allocated to the terminal is received, the base station may transmit scheduling information (e.g., PDCCH) of a physical radio resource for transmission of the RA MSG-B by using the corresponding scheduling identifier.

In the step S703, the base station may transmit only a PDCCH for allocating an uplink radio resource, transmit only a PDCCH (e.g., DCI type) for RA response, or transmit a random access response message on a PDSCH. In the case that only the PDCCH allocating an uplink radio resource is transmitted in the step S703, the corresponding DCI may include one or more among uplink resource allocation information (e.g., scheduling information), transmission timing adjustment information (e.g., a timing advance (TA) value, a TA command), transmission power adjustment information, backoff information, beam configuration information or TCI state information, configured scheduling (CS) state information, state transition information, PUCCH configuration information, index of the MSG-A received in the step S702, and uplink resource allocation information for transmission of the RA payload of the MSG-A. Here, the beam configuration information may be information indicating activation or deactivation of a specific beam. The TCI state information may be information indicating activation or deactivation of a specific TCI state. The CS state information may be information indicating activation or deactivation of a radio resource allocated in the CS scheme. The state transition information may be information indicating transition of the operation state of the terminal shown in FIG. 5. The state transition information may indicate transition from a specific operation state to the RRC idle state, the RRC connected state, or the RRC inactive state. Alternatively, the state transition information may indicate maintaining of the current operation state. The PUCCH configuration information may be allocation information of a scheduling request (SR) resource. Alternatively, the PUCCH configuration information may be information indicating activation or deactivation of an SR resource.

In addition, the base station may transmit only the above-described PDCCH and transmit the control information by using a PDSCH radio resource in the step S703. That is, the base station may generate and transmit the uplink radio resource allocation (or scheduling) information, transmission timing adjustment information, transmission power adjustment information, backoff information, beam configuration or TCI state information, configured scheduled (CS) state information, state transition information, PUCCH configuration information, index of the RA preamble of the MSG-A transmitted by the terminal in the step S702, or uplink radio resource allocation information for the terminal to transmit a message in a step S704.

The base station may transmit only the PDCCH for RA response in the step S703. In this case, the control information may be transmitted through a PDSCH. That is, the control information may include one or more among uplink resource allocation information (e.g., scheduling information), transmission timing adjustment information (e.g., TA value, TA command), transmission power adjustment information, backoff information, beam configuration information or TCI state information, configured scheduling (CS) state information, state transition information, PUCCH configuration information, index of the RA preamble of the MSG-A received in the step S702, and uplink resource allocation for transmission of the RA MSG-B in the step S704.

For the generation and transmission of the RA MSG-B in the step S703, the base station may transmit the PDCCH including scheduling information for transmission of the RA MSG-B by using the RA-RNTI or the scheduling identifier (C-RNTI) allocated to the terminal. The random access response message (i.e., RA MSG-B) may be transmitted using a PDSCH resource addressed by the scheduling information in the corresponding PDCCH.

When the terminal successfully receives the RA MSG-B of the step S703 transmitted by the base station, the 2-step RA procedure is terminated. In addition, the terminal receiving the RA MSG-B of the step S703 may generate and transmit uplink data or a control message by using the uplink scheduling information transmitted by the base station (S704).

The base station may notify the terminal of information on whether the base station (or cell) allows the 2-step RA procedure or control information such as a condition for the terminal to attempt the 2-step RA procedure by using system information transmitted in a broadcast scheme, control signaling transmitted in a multicast scheme, or a dedicated control message. Here, the information on whether the 2-step RA procedure is allowed refers to information on whether the base station allows or restricts (or partially prohibits) an access attempt using the 2-step RA procedure to the terminal(s) within the service coverage. When the 2-step RA procedure is restricted, information on a condition for which the 2-step RA procedure is restricted or partially prohibited may be transmitted to the terminal. If the base station (or cell) does not allow the 2-step RA procedure or the condition for restricting (or partially prohibiting) the 2-step RA procedure is satisfied, the terminal may not attempt the 2-step RA procedure.

The information on the condition under which the terminal can attempt the 2-step RA procedure is information for allowing the terminal to perform the 2-step RA procedure only when the corresponding condition is satisfied. For example, the terminal may be controlled to perform the 2-step RA procedure only when the quality of the radio channel measured by the terminal satisfies a reference condition (or threshold) configured by the base station using the above control information. Here, the quality of the radio channel may be, for example, a received signal strength indicator (RSSI), received signal code power (RSCP), reference signal received power (RSRP), or reference signal received quality (RSRQ). Alternatively, the quality of the radio channel is a reference parameter for measuring a quality of a radio section between the base station (or cell, TRP, etc.) and the terminal. The RA preamble (or signature) of the RA MSG1 for the 4-step RA procedure and the RA preamble (or signature) of the MSG-A for the 2-step RA procedure may be configured identically. That is, code sequences generated using the same code generation formula may be used as the RA preamble (or signature) of the RA MSG1 for the 4-step RA procedure and the RA preamble of the MSG-A for the 2-step RA procedure. However, in this case, the uplink physical layer radio resource for transmission of the RA preamble or the RA preamble index used by the terminal in the 2-step RA procedure may be configured differently from the uplink physical layer radio resource for transmission of the RA preamble or the RA preamble index used by the terminal in the 4-step RA procedure. As a method of configuring different uplink physical layer radio resources, a method of configuring the RA radio resources differently in the time domain or in the frequency domain, or a method of configuring the RA radio resources differently in the time domain and frequency domain may be used. In the frequency domain, the radio resource may be configured with an indicator or index for identifying a frequency band, band, subcarrier, or beam according to a beamforming technique. In the time domain, the radio resource may be configured with an indicator, index, or number for identifying a transmission (or reception) time unit(s) (or periodicity, period, window) such as a radio frame, subframe, transmission time interval (TTI), slot, mini-slot, or symbol. Therefore, the base station may determine whether the corresponding RA preamble is an RA preamble for the 2-step RA procedure or an RA preamble for the 4-step RA procedure only by receiving the RA preamble transmitted by the terminal or only by the uplink physical layer resource used by the terminal for transmission of the RA preamble.

Using the above-described 2-step RA procedure, the terminal may perform a procedure for transmitting an intermittently occurring uplink instant message. When transmission of an uplink instant message is required, the terminal in the inactive state or idle state may trigger an operation for transmission of the MSG-A according to FIG. 7. That is, when a condition preconfigured for transmission of an intermittently occurring uplink instant message is satisfied, the terminal may perform the step S702 for transmission of the MSG-A satisfying the above-described condition. In this case, the terminal transmits the RA payload of the MSG-A including control information for transmission of the uplink instant message.

That is, one or more among the above-described uplink instant message request (or transmission) indication information and/or the size of the uplink instant message (e.g., the size of the MAC PDU or RRC message), indicator indicating the range of the size of the uplink instant message, number of messages for the uplink instance message (e.g., the number of the MAC PDUs or RRC messages), uplink buffer size information (e.g., BSR), control message for requesting connection configuration, information indicating whether the size of the uplink instant message satisfies a preconfigured condition, uplink radio resource allocation request information, radio channel measurement result, and information on the desired terminal state after the transmission of the uplink instant message is completed may be included in the RA payload of the MSG-A. When the control information is transmitted as a MAC layer message, whether the corresponding control information exists and/or a control information value (or configuration parameter range) may be delivered in form of a MAC (sub)header or a MAC (sub)PDU. For this, a separate logical channel identifier (LCID) may be configured.

As a method of classifying random access radio resource groups for instant message transmission, a method of classifying and configuring indices of random access occasions (ROs) for transmission of the MSG-A and/or RA preambles of the MSG-A may be considered. That is, in the radio resource configuration of random access occasions, the MSG-A radio resource(s) used for the RA procedure not for instant message transmission, and the MSG-A radio resource(s) used for the RA procedure for instant message transmission may be configured separately. In addition, indices of the RO configuration parameters and/or RA preambles of the MSG-A for instant message transmission may be configured separately. The base station may select the RO configuration parameter and RA preamble of the MSG-A according to the size or type (or form) of the uplink instant message and/or the channel quality of the radio link (path loss, RSRP, RSRQ, etc.).

That the random access radio resources for instant message transmission are configured differently may mean that the terminal transmits the RA preambles or RA payloads by differently configuring positions or indices of the uplink radio resources (e.g., radio resources in the time domain and/or frequency domain) for the MSG-A preambles and/or MSG-A payloads, indices of the RA preambles, transmission timings, or offset values.

The configuration or format of the RA payload of the MSG-A for instant message transmission may be different from the configuration or format of the RA payload of the MSG-A for a general RA procedure. That is, the base station may configure a radio resource for the RA payload of the MSG-A for instant message transmission to be larger than a radio resource for the RA payload of the MSG-A for a general RA procedure, so that an instant message larger than a message (or transport block) transmitted as the RA payload of the MSG-A for a general RA procedure can be transmitted. Accordingly, the terminal may transmit information indicating transmission of the instant message in the configuration or format of the RA payload of the MSG-A for instant message transmission. Based on the indication information, the RA payload of the MSG-A for instant message transmission may be distinguished from the RA payload of the MSG-A for a purpose other than instant message transmission.

After the reception of the MSG-A of the step S702 or completion of the RA procedure, the base station may determine whether to transition the state of the terminal based on the above-described BSR information, the size (or size range) of the uplink instant message, or the information indicating whether the reference condition is satisfied, which is received from the terminal through a control message (e.g., MAC layer or RRC control message, etc.). For example, if a reference condition for the terminal in the inactive or idle state to transmit uplink data without transitioning to the connected state is satisfied, the base station may control the terminal to transmit the corresponding message in the inactive state or to transition to the inactive state or idle state after transmitting the corresponding message.

In addition, from the RA payload of the MSG-A transmitted by the terminal for the transmission of the uplink instant message, the base station may obtain information such as information on whether the instant message is transmitted as segmented (or whether the instant message transmitted as one-time transmission), the size of the uplink instant message (e.g., the size of the MAC PDU or RRC message, etc.), and/or the number of messages for the uplink instant message. The base station obtaining the information may transmit allocation (or scheduling) information for uplink radio resources for transmission of two or more segmented instant messages to the terminal rather than one-time transmission (or one-shot transmission). In this case, the allocation (or scheduling) information for uplink radio resources after the RA payload of the MSG-A may be transmitted in form of uplink grant information in the MSG-B or a separate MAC (sub)header and/or MAC CE, or may be transmitted in form of a physical layer control channel (PDCCH or DCI). When the allocation (or scheduling) information for uplink radio resources is transmitted through a physical layer control channel (PDCCH or DCI), the allocation (or scheduling) information for uplink radio resources may be transmitted to the terminal through resources of a CORESET configured for uplink instant message transmission.

When the 2-step RA procedure is performed for instant message transmission, the format (or parameter configuration) of the response message (RA MSG-B) for the RA MSG-A transmitted by the terminal may be different from the format (or parameter configuration) of the RA response message (RA MSG-B) for other purposes. That is, the response message (RA MSG-B) for the RA MSG-A transmitted by the terminal for instant message transmission may include allocation information for an uplink radio resource for instant message transmission.

In this case, the MAC subheader for the RA MSG-B may include field parameter (or indicator) information indicating that the corresponding RA MSG-B is the RA MSG-B according to the 2-step RA procedure for instant message transmission. For example, a corresponding indicator (or bit) set to ‘1’ may indicate that the RA MSG-B includes uplink radio resource allocation information for instant message transmission, or that the RA MSG-B is the RA MSG-B of the 2-step RA procedure performed for instant message transmission. The corresponding indicator (or bit) set to ‘0’ may indicate that the RA MSG-B does not include uplink radio resource allocation information for instant message transmission, or that the RA MSG-B is an RA MSG-B of a 2-step RA procedure performed for a purpose other than instant message transmission.

In addition, the RA MSG-B of the 2-step RA procedure performed for instant message transmission may include the terminal identifier for instant message transmission, transmission power adjustment information (e.g., TPC), PUCCH resource indicator, transmission timing adjustment information (e.g., timing advance command), MCS index, and/or uplink radio resource allocation information (or PUSCH resource indicator) for instant message transmission. Here, the terminal identifier for instant message transmission may be an identifier assigned to the terminal to identify the terminal in the inactive state, I-RNTI of the 3GPP NR system, a terminal identifier in an RRC resume request message (e.g., resumeIdentity, I-RNTI, or ShortI-RNTI of the 3GPP NR system, etc.).

When the terminal requests transmission of a message larger than a reference condition (or threshold), the base station may control the terminal to transition to the connected state and transmit the corresponding message. In addition, when determining that it is necessary, the base station may indicate or control the terminal performing the RA random access procedure to transition to the connected state or inactive state to perform uplink transmission or downlink reception operation by using the response message or a separate control message.

The base station may transmit the scheduling information of the uplink radio resource to the terminal in the step S704 or after the step S704 so that the terminal transmits the uplink instant message. The uplink scheduling information may be transmitted on a PDCCH or PDSCH. In this case, a scheduling identifier may be the C-RNTI included in the MSG-B of the step S703 or the above-described RTNI for instant message transmission (e.g., IM-RNTI). The terminal may transmit the uplink instant message using an uplink radio resource allocated by the corresponding scheduling information.

When the uplink instant message is transmitted based on the above-described RA procedure, the size of the RA MSG3 or the RA payload of the MSG-A transmitting the instant message may be different from the size of the RA MSG3 or the RA payload of the MSG-A for general RA purposes. That is, according to the size of the instant message that the terminal intends to transmit and/or the channel quality (e.g., CSI level, RSRP, RSRQ, or path loss, etc.) of the radio link measured (or estimated) by the terminal, the size of the RA MSG3 or the RA payload of the MSG-A transmitting the instant message may be variably configured. Accordingly, random access parameters for instant message transmission may be configured differently. The base station may configure available RA preamble (RA preamble of RA MSG1 or MSG-A) resources as one or more group(s) according to the size of the uplink instant message and/or the channel quality of the radio link measured by the terminal, and deliver configuration information for each group to the terminal by using system information or an RRC control message.

In addition, according to the size of the uplink instant message and/or the channel quality of the radio link measured by the terminal, the base station may configure MCS levels applicable to the RA MSG3 or the payload of the MSG-A as one or more groups, and deliver configuration information for each group to the terminal by using system information or an RRC control message. The corresponding MCS information may be configured in form of a list or range having one or more MCS values. Based on the size of the instant message to be transmitted and/or the measurement result of the channel quality (e.g., CSI level, RSRP, RSRQ, etc.), the terminal may select and transmit an RA preamble resource satisfying a condition among the available RA preamble (RA preambles of the RA MSG1 or the RA MSG-A) resources. In addition, based on the size of the instant message to be transmitted and/or the measurement result of the channel quality (e.g., CSI level, RSRP, RSRQ, etc.), the terminal may select and apply an MCS value satisfying a condition from the MCS list (or range).

When the base station does not deliver information on the MCS to be applied to the RA MSG3 or the RA payload of the MSG-A to the terminal, the terminal may select an MCS value and transmit the RA MSG3 or the RA payload of the MSG-A to which the selected MCS is applied as the instant message. In this case, the terminal may transmit information on the applied MCS (or, PUR MCS index) by including it in the RA MSG3 or the RA payload of the MSG-A transmitting the instant message. The MCS indicator transmitted by the terminal may be composed of one or more bit(s), and may be transmitted as configured as a control parameter having a fixed format in a specific radio resource region constituting the RA MSG3 or the RA payload of the MSG-A. Accordingly, the base station may acquire information on the MCS applied to the instant message from the MCS indicator of the radio resource of the RA MSG3 or the RA payload of the MSG-A received from the terminal, and perform demodulation and decoding operations according to the MCS.

As described above, the base station may configure available RA preamble (RA preamble of RA MSG1 or MSG-A) resources and/or sizes of uplink radio resources (e.g., sizes of RA MSG3 or RA payload of MSG-A) for instant message transmission as one or more group(s) according to the size of the uplink instant message and/or the channel quality of the radio link measured by the terminal, and deliver configuration information for each group to the terminal by using system information or an RRC control message. That is, from the system information or the RRC control message, the terminal may obtain, for instant message transmission, information on one or more RA preamble (RA preamble of RA MSG1 or MSG-A) group(s) and/or configuration information on uplink radio resources (radio resources of RA MSG3 or RA payload of MSG-A) configured based on the size of the instant message and/or the channel quality of the radio link measured by the terminal.

Accordingly, the terminal may select an RA preamble (RA preamble of RA MSG1 or RA MSG-A) corresponding to the size of the uplink instant message to be transmitted and/or the channel quality of the radio link measured by the terminal. In addition, the terminal may select or determine an uplink radio resource (radio resource of RA MSG3 or RA payload of MSG-A) corresponding to the size of the uplink instant message to be transmitted and/or the channel quality of the radio link measured by the terminal.

When the uplink instant message is transmitted as segmented based on the RA procedure, the base station may configure RA preamble(s) of RA MSG1 (or RA preamble(s) of RA MSG-A) for segmented transmission. In addition, the base station may allocate (or configure) a plurality of uplink radio resources for segmented transmission of the instant message continuously or discretely in the time domain and/or the frequency domain. Accordingly, the terminal may segment and transmit the uplink instant message by using the plurality of uplink radio resources allocated for the segmented transmission. The uplink radio resources for the segmented transmission of the instant message may be allocated or scheduled by using at least one of the following schemes.
A scheme of allocating a plurality of uplink radio resources having a correspondence relationship with RA radio resources (ROs, RA preambles, and/or radio resources of RA payload of MSG-A) for segmented transmission of an instant message
A scheme of transmitting scheduling information for one or more uplink radio resource(s) through an RA response message (e.g., RA MSG 2 or RA MSG-B)
A scheme of transmitting scheduling information for each transmission unit of an instant message, or transmitting scheduling information for a plurality of uplink radio resources for segmented transmission of an instant message through a PDCCH using a scheduling identifier (e.g., IM-RNTI or SDT-RNTI, etc.) configured for segmented transmission of an instant message or for instant message transmission

In the above-described transmission method of uplink radio resource allocation (or scheduling) information for segmented transmission of an instant message, when using an RA response message, allocation (or scheduling) information of an uplink radio resource after the RA MSG3 and/or the RA payload of the MSG-A may be transmitted in form of uplink grant information in the MSG-B or a separate MAC (sub)header and/or MAC CE. In case of using a PDCCH, the uplink scheduling information for instant message transmission may be delivered to the terminal on a PDCCH through a resource of a CORESET designated for uplink instant message transmission.

In the above-described RA procedure-based instant message transmission method, the uplink radio resource allocation information delivered to the terminal by using the response message (RA MSG2) for the RA MSG1, the response message (RA MSG-B) for the RA MSG-A, or the PDCCH (or IM DCI format) for instant message transmission may include at least one among the following parameters. Here, the IM DCI format may be a format for control information for allocating (or scheduling) the uplink radio resource for instant message transmission, which is transmitted on a PDCCH.
Uplink BWP index and/or BWP activation indicator
Downlink/Uplink beam configuration and/or TCI configuration information

The beam configuration and/or TCI configuration information, as information on a beam or TCI state for instant message transmission, may be configured using a candidate beam list and/or an indicator for an activated TCI state.

Allocation information of a frequency-domain and/or time-domain uplink radio resource for instant message transmission

Here, the uplink radio resource allocation information may be one-time allocation information, allocation information of a plurality of resources, and/or repetitive allocation information. In addition, the corresponding allocation information may be configured as a parameter for continuously or discretely allocating radio resources within a predetermined period.

The corresponding radio resource allocation information may be configured with a start point, end point, and/or length (or size) of a frequency-domain and/or time domain-uplink radio resource (or an index indicating the position of the radio resource).

A time period (or timer) in which the allocated uplink radio resource is valid and/or transmission timing configuration information of the allocated uplink radio resource

Here, the time period (or timer) and/or transmission timing may be configured in units of symbols, mini-slots, slots, subframes, or frames, or may be configured as an absolute time (e.g., seconds, milliseconds, etc.). The time period (or timer) may be configured with parameter(s) such as a start time, end time, duration, reference time, and/or offset, and the terminal may perform instant message transmission by using the uplink radio resource within the time period (or until the timer expires).

Radio channel quality condition and/or size information of the instant message for performing instant message transmission

Here, when a radio channel quality condition (e.g., a condition configured as a parameter such as RSRP, RSRQ, CSI-RS, RSSI, or path loss) is satisfied, instant message transmission may be performed with the allocated uplink radio resource.

The size information of the instant message may include a maximum size and/or a minimum size of the instant message that can be transmitted through the allocated uplink radio resource.

Modulation and coding scheme (MCS) configuration (or MCS level indicator) information for instant message transmission

One or more MCS configuration(s) (or MCS level indicator(s)) may be configured, and the terminal may select an MCS satisfying the condition from among the plurality of MCSs based on the radio channel quality condition described above.

Among the above-described control information constituting the PDCCH (or IM DCI format) for instant message transmission, parameters that are not transmitted on the PDCCH (or IM DCI format) may be transmitted to the terminal in form of a MAC CE by using a PDSCH.

When the instant message is transmitted as segmented as described above, each segment of the instant message may be configured by selectively including a number indicating an order of the segment for reassembly, an indicator indicating a first segment, an indicator indicating an intermediate segment, and/or an indicator indicating a last segment.

When instant message transmission is performed using the above-described RA procedure, the terminal may start the instant message transmission by transmitting a resume request message through the RA MSG3 and/or the RA payload of the MSG-A. In this case, the resume request message may be transmitted by setting a resume cause within the resume request message as ‘instant message transmission’. The resume cause in the resume request message for instant message transmission may indicate one-time transmission or segmented transmission of the instant message. Alternatively, the resume cause in the resume request message may indicate only whether or not the instant message is transmitted as one-time transmission. When the resume cause in the resume request message indicates only the transmission of the instant message without distinguishing between one-time transmission and segmented transmission, the terminal may transmit a scheduling request through a scheduled uplink radio resource on a physical control channel after transmitting the RA MSG3 and/or the RA payload of the MSG-A, and transmit buffer status information (BSR), information requesting segmented transmission of the instant message, and information notifying that segmented transmission or uplink resource allocation for the segmented transmission is required by using a control message (e.g., MAC CE or RRC control message). In addition, the terminal may transmit a logical channel identifier (LCID) for identifying a bearer (DRB or SRB) required for transmission of the instant message packet by using a control message (or resume request message) for requesting instant message transmission.

Even when instant message transmission is initiated by transmitting a control message configured for requesting instant message transmission by using the RA MSG3 and/or the RA payload of the MSG-A, the corresponding message may include information indicating the cause (or form, type) of the instant message transmission request. The cause (or, form, type) of the instant message transmission request in the instant message transmission request message may indicate one-time transmission or segmented transmission of the instant message. Alternatively, the cause of the instant message transmission request may indicate only whether or not the instant message is transmitted as one-time transmission. When the cause of the instant message transmission request indicates only the transmission of the instant message without distinguishing between one-time transmission and segmented transmission, the terminal may transmit a scheduling request through a scheduled uplink radio resource on a physical control channel after transmitting the RA MSG3 and/or the RA payload of the MSG-A, and transmit buffer status information (BSR), information requesting segmented transmission of the instant message, and information notifying that segmented transmission or uplink resource allocation for the segmented transmission is required by using a control message (e.g., MAC CE or RRC control message).

RA radio resources may be configured separately as RA radio resources for the RA procedure not for instant message transmission, and RA radio resources for the RA procedure for instant message transmission. In the above-described two types of RA procedures, RA radio resources for the 2-step RA procedure and/or the 4-step RA procedure may be separately configured. When transmitting an uplink instant message by using the RA procedure, in consideration of the above-described radio channel quality condition, whether the uplink physical layer synchronization is maintained, the size condition of the instant message, whether the instant message is transmitted as segmented, and/or RA radio resource configuration (e.g., RO, RA preamble group, RA-MSG3, RA payload size of MSG-A, etc.), the terminal may determine which RA procedure to perform according to the following methods.

Method 1:
First step: The terminal selects one of an RA procedure not for instant message transmission and an RA procedure for instant message transmission.
Second step: The terminal selects the 2-step RA procedure or the 4-step RA procedure for the RA procedure selected in the first step.

Method 2:
First step: The terminal selects the 2-step RA procedure or the 4-step RA procedure as an RA type for instant message transmission.
Second step: For the RA type selected in the first step, the terminal selects one of an RA procedure not for instant message transmission and an RA procedure for instant message transmission.

Method 3: The terminal select one among the follows four procedure.
The 2-step RA procedure not for instant message transmission
The 4-step RA procedure not for instant message transmission
The 2-step RA procedure for instant message transmission
The 4-step RA procedure for instant message transmission

### Uplink Instant Message Transmission Method Using a PUR

The terminal may transmit an uplink instant message by using a PUR. An uplink PUR for instant message transmission may be configured as a PUSCH resource for instant message transmission, or may be configured as a PUSCH resource allocated to the terminal (or terminal group) in a configured grant (CG) scheme. Alternatively, an uplink PUR for instant message transmission may be configured similarly to the MSG-A of the step 2 RA procedure of FIG. 7. When a PUR for instant message transmission is configured similarly to the MSG-A, the PUR may be configured as a PUSCH resource for transmitting an instant message together with a bit string (or sequence) having a predetermined pattern in form of a preamble, reference signal, or pilot symbol.

In the following description, a PUR (or PUR radio resource) may be configured as a PUSCH resource for instant message transmission, configured as a PUSCH resource allocated to the terminal (or terminal group) in the CG scheme, or configured as a PUSCH for instant message transmission and a bit string pattern of a preamble (or, reference signal, pilot symbol, etc.).

The base station may deliver configuration information of PUR(s) for instant message transmission (hereinafter, PUR configuration information) or configuration information of PUSCH resource(s) allocated to the terminal (or terminal group) in the CG scheme by using system information or a dedicated control message. Here, the dedicated control message may be a control message for configuring an RRC connection, a control message for releasing an RRC connection, or an RRC state transition control message (e.g., a control message for transition to the inactive state).

The PUR configuration information for instant message transmission (unless otherwise described below, PUR configuration information refers to configuration information of PUSCH resource(s) allocated to the terminal (or terminal group) in the CG scheme) may be applied to or valid only for the base station configuring or signaling the PUR configuration information. Accordingly, the base station may transmit PUR configuration information of a neighboring base station to the terminal as system information. The PUR configuration information of a neighboring base station included in the system information may be configured in form of a list consisting of PUR configuration information of one or more neighboring base station(s).

When a terminal in the inactive state moves from the base station to which the received PUR configuration information is applied to another base station, the terminal may obtain PUR configuration information again from the new base station. To this end, the terminal may perform a procedure of acquiring the PUR configuration information whenever entering a new base station, or may acquire PUR configuration information of a new base station by using system information. Alternatively, the terminal may acquire PUR configuration information of the corresponding base station in a step of performing a resume procedure (e.g., a resume procedure according to a condition for a resume procedure according to a timer-based or a routing area update condition) that satisfies an execution condition other than the purpose of instant message transmission.

Even when the terminal in the inactive state enters a new base station as described above, if the PUR configuration information is configured in form of a list of PUR configuration information for one or more base station(s), the terminal may perform an instant message transmission procedure by activating the PUR configuration corresponding to the new base station in the list.

Alternatively, PUR(s) applicable to a plurality of base stations may be configured for the terminal in the inactive state. To this end, the base station may configure an uplink, supplementary uplink (SUL), and/or BWP for PUR(s) shared or partially overlapped with neighboring base stations. As described above, shared or partially overlapped PUR(s) (e.g., UL, SUL, BWP, etc.) may be configured for instant message transmission between a plurality of base stations. Hereinafter, PUR(s) that are shared or partially overlapped between a plurality of base stations may be referred to as shared PUR(s) or shared PUR radio resource(s). The shared PUR configuration information delivered to the terminal may be configured to include an indicator or identifier information capable of determining whether the shared PUR configured from a previous base station is valid (or whether the shared PUR radio resource can be used) for the inactive terminal entering a new base station. When the shared PUR radio resource(s) is configured to a plurality of base stations as described above, if the shared PUR radio resource configured by a previous base station is valid, the inactive terminal entering a new base station may use the shared PUR according to the PUR configuration information to perform an instant message transmission procedure. If the shared PUR radio resource configured from a previous base station is not valid, the inactive terminal entering a new base station may acquire PUR configuration information for the new base station by using a resume procedure or a separate PUR configuration procedure.

The base station may transmit PUR configuration information to the terminal using system information or configure an uplink radio resource for triggering (or initiating) the PUR configuration procedure to the terminal so that the inactive terminal entering the new base station acquires a PUR. Therefore, the inactive terminal entering the new base station may trigger (or initiate) the PUR configuration procedure by using the radio resource without transition to the connected state, transmit buffer state information (e.g., BSR MAC CE), or acquire a PUR radio resource.

When the terminal in the inactive state performs a resume procedure or a separate PUR configuration procedure to acquire PUR configuration information for a new base station, in the step of triggering or initiating the resume procedure or the separate PUR configuration procedure, the terminal may perform a procedure of explicitly releasing the PUR(s) configured from the previous base station by transmitting control information notifying that the PUR(s) configured from the previous base station has been released. Alternatively, the terminal may proceed with the procedure of releasing the PUR(s) configured from the previous base station in an implicit method without transmitting the explicit control information. In order to support the method of implicitly releasing the PUR(s), the base station may deliver indication information indicating whether to allow the implicit PUR release of the terminal to the terminal in form of a control message or system information for PUR parameter configuration. Alternatively, the PUR release function of the terminal may not be applied by not configuring a timer value for PUR release described below or by setting it to an infinite value. Alternatively, the operation according to indication information indicating whether to allow the implicit PUR release of the terminal or the timer for PUR release may be deactivated or disabled. In addition, parameters constituting the PUR configuration information may be selectively configured by excluding (or disabling) some of lower parameters constituting the PUR configuration information for a terminal having a specific capability and/or property based on the capability and/or property information of the terminals, thereby determining or configuring whether to apply the implicit PUR release function.

Accordingly, when preconfigured condition(s) are satisfied, the terminal may perform the procedure of releasing the PUR(s). The condition(s) for releasing the configured PUR(s) are as follows.
When the number of times transmission using the configured PUR(s) is omitted or not performed reaches a preconfigured value (e.g., PUR_Non_Tx_CNT)
When the next PUR transmission does not occur or fails until a preconfigured timer (e.g., PUR resource release timer #1) expires
When a radio channel quality of a downlink channel (e.g., SSB, reference signal, BWP, configured beam (or TCI index)) of the base station corresponding to (or mapped to) the configured PUR does not satisfy a preconfigured condition until a preconfigured timer (e.g., PUR resource release timer #2) expires
When a terminal entering a new base station acquires PUR configuration information for the new base station by using a resume procedure or a separate PUR configuration procedure

The above-described PUR resource release timer #1 and PUR resource release timer #2 may be started after transmission using a PUR is initiated (started) or may be started or restarted when transmission using a previous (or last) PUR is performed. In addition, the PUR resource release timer #1 and the PUR resource release timer #2 may be configured to start/restart when a condition for determining whether the terminal is located at a cell boundary is satisfied. Here, the condition for determining whether the terminal is located at a cell boundary may use parameters such as the radio channel quality and/or position information of the terminal. The quality of the radio channel may be determined by whether or not the channel quality (e.g., RSRP, RSRQ, RSSI, SNR, SIR, etc.) of the serving cell and/or the neighboring cell satisfies a preconfigured condition. In addition, the position information of the terminal may be determined by information on a time for which a quality condition of the radio channel is satisfied and/or whether geographic position information of the terminal satisfies a preconfigured condition. Here, the geographic position information of the terminal may refer to position information of the terminal estimated (or measured) using a satellite for position measurement, a built-in sensor of the terminal, and/or a positioning reference signal (PRS).

The determination on whether transmission using a PUR has been performed or the calculation (or counting) of the number of times that transmission using a PUR has been omitted or not performed may include all of case(s) corresponding to the following conditions, or selectively include some of them.
When transmission using a PUR is not performed because the radio channel quality condition for performing instant message transmission is not satisfied
When transmission using a PUR is not performed because there is no packet data of an instant message to be transmitted
When transmission using a PUR is not performed because the size condition of an instant message to be transmitted is not satisfied
When transmission using a PUR is not performed due to reasons such as BWP deactivation for the PUR, deactivation of a transmission beam (or TCI index) for the PUR, beam problem detection (BPD), and/or beam failure recovery (BFR)
When transmission using a PUR is not performed for all configured beams in case that a plurality of beams (or TCI indices) are configured

In addition, when a plurality of PURs are configured for instant message transmission, the determination on whether transmission using a PUR has been performed or the calculation (or counting) of the number of times that transmission using a PUR has been omitted or not performed may be performed for each SSB and/or reference signal (e.g., DM-RS, CSI-RS, and/or other reference signals) mapped to the PUR. That is, based on the result of determining whether the transmission using the corresponding PUR has been performed, and/or the calculation (or counting) of the number of times the transmission using the corresponding PUR has been omitted or not performed by using the SSB and/or reference signal mapped to the PUR, it may be determined whether to release the corresponding PUR.

When the PUR release is determined according to the above-described PUR release method, the release of the PUR may be actually applied or performed when the following condition(s) are satisfied.

When a preconfigured time elapses (or a related timer (e.g., PUR resource release application timer) expires) from a time when the terminal leaves the base station by which the PUR determined to be released is configured or a time when the terminal enters a new base station

The PUR resource release application timer may start when the terminal leaves the base station by which the PUR determined to be released is configured, or when the terminal enters a new base station. In addition, the PUR resource release application timer may be configured to (re)start when the above-described condition for determining whether the terminal is located at a cell boundary is satisfied.

When the terminal enters a base station with an area identifier different from an area identifier of the base station by which the PUR determined to be released is configured

Here, the area identifier of the base station may refer to identifier information for identifying an area to which one or more base station(s) belong, such as a RAN area (or RAN-based notification area (RNA)) ID or a tracking area ID.

As described above, when a predetermined time elapses (or timer expires) from the time when the PUR is determined to be released, or when the PUR determined to be released is actually released when the terminal is out of a predetermined area, if the terminal re-enters the base station in which the PUR determined to be released is configured before the corresponding timer expires, the terminal may reuse the PUR without releasing the PUR.

When the PUR is released according to the above-described PUR release method, the terminal may release the PUR in an implicit method without transmitting control information notifying the release of the PUR to the base station. However, when the base station and/or system indicates (or configures) the terminal to transmit control information notifying the release of the configured PUR, the terminal may explicitly transmit a control message notifying the release of the configured PUR to release the configured PUR. In addition, when the terminal in the inactive state entering a new base station acquires a PUR from the new base station based on the resume procedure, the new base station and/or the previous base station may release the PUR configured by the previous base station or exchange information that the PUR has been released in a step of transferring (or exchanging) of context information of the terminal.

In addition, when the PUR is released according to the above-described PUR release method, for the base station by which the released PUR is configured, the terminal may perform the above-described RA procedure-based uplink instant message transmission procedure or transmit a BSR MAC CE. In this case, the base station may determine that the configured PUR has been released by receiving the RA message and/or the BSR MAC CE transmitted by the terminal for instant message transmission.

In order for the terminal to determine PUR release or to actually perform the PUR release, the base station may include parameters in the PUR configuration information, such as the PUR_Non_Tx_CNT, PUR resource release timer #1, PUR resource release timer #2, PUR resource release application timer for determining whether transmission using a PUR has been performed or calculating (or counting) the number of times that transmission using a PUR has been omitted or not performed, and deliver the PUR configuration information to the terminal in form of a dedicated control message or system information. However, when applying the PUR release function based on the timer described above, the values of the related timers (e.g., PUR resource release timer #1, PUR resource release timer #2, and/or PUR resource release application timer, etc.) may not be set or may be set to infinite values, so that the PUR resource release function of the terminal may not be applied, or may be deactivated or disabled. In particular, the PUR release-related timer values may not be set or may be set to infinite values according to the capability and/or property of the terminal. Here, the capability of the terminal may refer to information constituting the capability level (or class) of the terminal supported by the system, including a reduced capability level terminal. In addition, the property of the terminal may refer to information constituting characteristics or reference conditions according to the type of the terminal (e.g., normal UE, IoT device, low cost device, wearable device, etc.) and mobility of the terminal (e.g., fixed, low/medium/high stationary, etc.). The capability and/or property information of the terminal may be stored in a USIM of the terminal, and may be delivered to the base station through a control message for the terminal to perform registration in the network, a control message for (re)establishing or releasing a connection with the network (or base station), and/or control information transmitted by the terminal according to the request (or configuration) of the network (or base station) (e.g., UE assistance information message, UE capability information message, or UE report message).

If the terminal that has received PUR configuration information from the previous base station does not apply the procedure for acquiring PUR configuration information from the new base station, the terminal may transmit an instant message to the new base station by performing the RA procedure-based instant message transmission procedure described above.

As another method, the PUR configuration information of the system information transmitted by the base station may be configured for each area composed of one or more base station(s) (e.g., tracking area, RAN area (e.g., RAN-based Notification Area (RNA)). When the PUR configuration information is commonly applied to one or more base station(s), the PUR configuration information may be identified using an identifier for an area to which the corresponding PUR configuration information is applied. As such the area identifier, a RAN area (or RNA) ID or a tracking area ID may be used, an identifier (e.g., system information area ID) indicating that system information is commonly applied to one or more base station(s) may be used, or a PUR area ID indicating an area to which the PUR configuration information is commonly applied to one or more base station(s) may be used. Therefore, even when the serving cell or camped cell of the terminal is changed, if the area identifier for PUR configuration information of the new serving cell or camped cell is the same as the area identifier of the previous serving cell or camped cell, the terminal may transmit an instant message by using the existing PUR configuration information without need to update or newly acquire PUR configuration information. For example, if a base station on which the terminal in the inactive state or idle state is camping through a cell (re)selection procedure is a base station belonging to the same area as the previous base station, the terminal may transmit an instant message by using the existing PUR configuration information. The above-described PUR configuration information for instant message transmission may be preconfigured or allocated for each terminal (or terminal group).

In addition, when PUR configuration information is commonly applied to one or more base station(s), the corresponding PUR configuration information may include an identifier for uniquely identifying a specific terminal or a specific terminal group in a corresponding area. That is, in an area identified by the above-described RAN area (or RAN-based notification area (RNA)) ID, tracking area ID, system information area ID, or PUR area ID, an identifier (or an in-area terminal identifier) for indicating that the PUR configuration information is uniquely allocated to the specific terminal or the specific terminal group may be used. Accordingly, the specific terminal or terminal group may transmit an instant message using the PUR allocated (or configured) to the specific terminal or terminal group, and collision with another terminal or terminal group may be avoided. In this case, when the specific terminal or terminal group transmits an instant message by using the PUR, the specific terminal or terminal group may transmit the instant message by masking (at least a part of) the instant message with the identifier (or in-area terminal identifier) allocated to the terminal or terminal group, or transmit the instant message by including the corresponding identifier in the instant message.

The above-described PUR configuration information for instant message transmission may be allocated to the terminal by using a control message in a connection setup step or a connection resume step, or a control message for state transition (or connection release).

The above-described PUR configuration information for instant message transmission may be configured or allocated by using a contention-based or contention-free uplink channel. The PUR for instant message transmission may be a channel (or radio resource) allocated to a terminal (or terminal group) existing (or located) in a service area that satisfies a preconfigured condition.

The above-described PUR configuration information for instant message transmission may include PUR radio resource allocation information (a bit string and/or PUSCH for PUR transmission), MCS information, HARQ configuration information, transmission timing, or information for PUR mapping between base stations in the PUR area. Here, the PUR radio resource allocation information may include the identifier of the terminal or terminal group to which the PUR is allocated (or configured), whether the PUR is allocated one-time, whether the PUR is repeatedly allocated, and/or the number of times that the PUR is repeatedly allocated.

In addition, the PUR radio resource allocation information may refer to allocation information of a physical layer radio resource (e.g., physical resource block (PRB)) constituting the PUR in the time domain and/or the frequency domain. The PUR radio resource allocation information may include an index of a subcarrier where the PUR radio resource starts in the frequency domain (e.g., system bandwidth, BWP, or subcarrier, etc.) or an offset from a predetermined reference (e.g., a start point of subcarriers constituting a system bandwidth or a BWP), a BWP index of the PUR radio resource, information on the number of subcarriers or subchannels of the PUR radio resource, and the like. Here, the BWP index of the PUR radio resource may be an indicator for identifying a BWP in which the PUR resource is configured and/or a BWP configured for instant message transmission. The base station may configure or designate one or more BWP(s) for instant message transmission. When the BWP index is delivered to the terminal using system information or a control message for connection configuration, the BWP index information may be excluded from the PUR radio resource allocation information. The PUR radio resource allocation information may include an index of a start position of the PUR radio resource (e.g., an index of a frame, subframe, slot, mini-slot, or symbol where the PUR resource starts) in the time domain (e.g., frame, subframe, slot, mini-slot, symbol, etc.) and/or the length of the PUR radio resource, PUR allocation period, a period (duration, window, or timer) in which the allocated PUR radio resource is valid, or transmission-possible period information. Here, the PUR allocation period may be configured in units of radio frames, subframes, slots, mini-slots, or symbols. In addition, the PUR allocation period may be indicated by a frame and/or subframe in which the PUR is transmitted, which is determined based on a modulo operation using the identifier of the terminal (e.g., IMSI, TMSI, S- TMSI, ResumeID, I-RNTI, C-RNTI, or other terminal identifiers) and/or a system frame number (SFN). A start point of slots, mini-slots, or symbols in the corresponding frame and/or subframe may be indicated by using offset information or offset information for the position where the PUR radio resource starts.

In addition, a date and time (e.g., year/month/day/time) when instant message transmission is requested may be specified, or a section for the date and time when instant message transmission is requested may be designated. In this case, the PUR for instant message transmission may be configured on a specific month every year and/or on a specific date (or date range) every month. Alternatively, the PUR for instant message transmission may be configured at a specific time (or time range) of a specified year, month, and day. The specific date and time may be configured based on time information such as a UTC, GPS, or the like.

The MCS information represents information on a modulation scheme and code rate applied when transmitting an instant message using the PUR. The MCS information may be configured in form of a list or range having one or more MCS values. The terminal may select an MCS value that satisfies a condition from the MCS list (or range) according to the size of the instant message to be transmitted and/or the measurement result of the channel quality (e.g., CSI level, RSRP, RSRQ, etc.). When the terminal is configured to transmit the instant message by selecting an MCS value, or when the base station does not deliver information on the MCS to be applied to the PUR to the terminal, the terminal may transmit information (e.g., PUR MCS indicator) on the MCS applied to the PUR for instant message transmission by including it in the instant message. The PUR MCS indicator transmitted by the terminal may be configured in form of one or more bits, and may be configured and transmitted as a control parameter of a fixed format in a specific radio resource region of the PUR. Accordingly, the base station may acquire information on the MCS applied to the instant message based on the PUR MCS indicator received from the terminal, and perform demodulation and decoding operations for receiving the instant message.

In addition, the transmission timing information may refer to a system frame number (SFN) of the PUR for instant message transmission, index of the frame/subframe/slot/mini-slot/symbol, offset information for the SFN/frame/subframe/slot/mini-slot/symbol, etc. that can be used for estimating a transmission time (or timing), a time window value, or the like. The transmission timing information may include a start point where the PUR radio resource starts in the time domain (e.g., frame, sub-frame, slot, or mini-slot, symbol, etc.) or information on an offset from a predetermined reference (e.g., a time reference point configured with an SFN or an index of frame/subframe, etc.). That is, the offset information may be offset information (e.g., in units of radio frames, subframes, slots, mini-slots, or symbols) from a start point of the PUR allocation period or a reference point of the SFN.

In addition, the HARQ configuration information may include information indicating whether a HARQ function is supported for the instant message and/or whether repetitive transmission is applied to the instant message, the number of repetitions, configuration information of the PUR to which repetitive transmission is applied, information on a time period to which the repetitive transmission is applied, or the like.

In addition, the information for PUR mapping between the base stations in the PUR area (hereinafter, PUR mapping information) may refer to information for mapping PUR(s) between base stations belonging to the same area when the PUR configuration includes information on shared PUR(s) commonly applied to one or more base station(s). For example, the mapping information may, even when different numerologies are applied to the base stations belonging to the area in which the same PUR configuration information is applied (or, the area to which the PUR configuration information having the same area identifier is applied), refer to information for the terminal to recognize a PUR radio resource and/or a shared PUR radio resource of a new base station according to the PUR configuration information. Therefore, the mapping information may include offset information or information on a conversion mapping rule between different numerologies, which is used for acquiring PUR configuration information to be actually applied to each of the base stations to which numerologies different with respect to transmission frequency/bandwidth, BWP configuration, subcarrier spacing, symbol length, or the like are applied. For example, when a BWP in which the PUR obtained from the previous base station is configured and a BWP of a new base station are different in subcarrier spacing, slot/mini-slot configuration, or symbol configuration, the mapping information may include information on a mapping rule for determining a PUR for each base station (or BWP), an index of the BWP in which the PUR is configured, and/or mapping information.

In addition, for beam management (or selection) according to application of a beamforming technique, the PUR configuration information may include information indicating a mapping relationship between a beam through the SSB and/or reference signal (e.g., DM-RS, CSI-RS, and/or other reference signal) is transmitted and a preamble (or pattern/sequence of a reference signal) radio resource for the PUR. When the PUR is composed of only a PUSCH without a preamble (or pattern/sequence of a reference signal), the PUR configuration information may include information indicating a mapping relationship between a beam through the SSB and/or reference signal (e.g., DM-RS, CSI-RS, and/or other reference signal) is transmitted and a PUSCH radio resource.

When the terminal performs instant message transmission by using the PUR configuration information, the terminal may transmit an instant message when the size condition of the instant message to be transmitted and/or the channel quality condition (e.g., condition configured with parameters such as RSRP, RSRQ, CSI-RS, RSSI, or path loss) is satisfied. For example, if the size of the instant message to be transmitted satisfies a preconfigured allowable size condition, the terminal may select a PUR mapped to (or corresponding to) an SSB and/or reference signal (e.g., DM-RS, CSI-RS, and/or other reference signal) satisfying the radio channel quality condition configured for instant message transmission, and transmit the instant message by using the selected PUR. In this case, in the step of starting the transmission of the instant message, the terminal may transmit information on an identifier for identifying a service of the instant message packet to be started or a logical channel identifier (LCID) for identifying a bearer (DRB or SRB) for the instant message packet to the base station.

In the case of allocating (or scheduling) an uplink radio resource for transmission of the instant message by using a PDCCH in addition to the above-described PUR configuration information, the corresponding PDCCH may include scheduling information for allocating the uplink radio resource for the instant message or information on a DCI format for instant message transmission (or the above-described IM DCI format).

In addition, when the PUR is configured as including a preamble (or reference signal, pilot symbol, etc.) bit string (pattern) for PUR, the PUR configuration information may include mapping information between an index (or radio resource) of the bit string (pattern) of the preamble for PUR and a PUSCH radio resource. Here, the index of the bit string (or sequence) of the preamble may refer to identification information capable of identifying the corresponding bit string (or sequence), such as an RA preamble index or a reference signal index. Such the preamble or reference signal may be designated in advance or configured to be located in a first or last symbol in the time domain of the corresponding uplink channel, located in a specific subcarrier in the frequency domain thereof, or mapped to RE(s) located in a specific time region and frequency region thereof.

The mapping information between the index (or radio resource) of the bit string (pattern) of the preamble for the PUR and the PUSCH radio resource may refer to a mapping relationship between the preamble (or reference signal) radio resource for the PUR and the PUSCH radio resource. For example, this may be information indicating a correspondence between the index of the preamble for the PUR (or the index of the pattern/sequence of the reference signal) and the PUSCH resource through which the instant message is transmitted.

In addition, the bit string and PUSCH resource of the PUR for instant message transmission may be composed of one PRB resource or a plurality of PRB resources using consecutive radio resources, or composed of PRB resources spaced apart in the frequency domain or the time domain. The terminal transmitting the instant message may transmit the instant message to the base station by using the PRB resource(s) of the PUR preconfigured or allocated by the base station as described above.

When the terminal transmits an uplink instant message by using a PUR, information indicating whether the instant message is transmitted as segmented (or information indicating whether the instant message is transmitted as one-time transmission) may be delivered together. Depending on whether the instant message is transmitted as segmented, the terminal may transmit a separate control message (e.g., MAC layer and/or RRC layer control message) in addition to the instant message. For example, when the instant message is transmitted as segmented (e.g., when two or more instant messages are transmitted through different time and/or frequency uplink radio resources), the terminal may deliver one or more among uplink radio resource request information for the transmission of segmented instant messages and/or the size of the uplink instant message (e.g., the size of the MAC PDU or RRC message, etc.), the number of messages for the uplink instant message (e.g., the number of the MAC PDUs or RRC messages, etc.), uplink buffer size information (e.g., BSR), a control message for connection configuration request, indication information indicating whether the size of the uplink instant message satisfies a preconfigured condition, information such as a radio channel measurement result, or a desired operation state of the terminal after completion of the instant message transmission. When the control information is transmitted as a MAC layer message, whether the corresponding control information exists and/or value(s) (or configuration parameter range(s)) of the control information may be delivered in form of a MAC (sub)header or a MAC (sub)PDU. For this, a separate logical channel identifier (LCID) may be configured.

When it is determined that segmented transmission is applied based on the control information received from the terminal, the base station may allocate PURs or uplink radio resources for the segmented transmission of the instant message to the terminal. In this case, frequency-domain configuration information of uplink radio resources and/or PURs for instant message transmission and time-domain configuration information such as a transmission start time and/or transmission end time, an instant message transmission period (or window, timer, counter), or a transmission periodicity within the transmission period may be delivered to the terminal. The time-domain configuration information may be configured in units of radio frames, subframes, slots, minislots, or symbols.

By using the uplink radio resource(s) for instant message transmission allocated from the base station, the terminal may transmit the instant message by segmenting it or transmit the instant message as one-time transmission. After transmitting the instant message, the terminal may release the corresponding PUR(s) according to configuration of the base station. In the case of one-time transmission of the instant message, the terminal may release the corresponding PUR. In addition, in the transmission step of the last segment of the instant message or the one-time transmission step of the instance message, the terminal may selectively transmit control information for requesting PUR configuration together. The terminal may transmit the PUR configuration/allocation request in form of a control field of uplink physical layer control information, a MAC control message, or an RRC control message. Here, the MAC control message may be configured in form of an LCID or MAC subheader indicating the PUR request, or may be configured in form of a MAC (sub)PDU including one or more of the above-described control information for instant message transmission.

In addition, when one or more of the following conditions are satisfied, the terminal may be restricted to transmit the instant message according to the above-described instant message transmission method using a PUR or the above-described method described in FIGS. 6 or 7.
When the size of the instant message is less than a predetermined size (e.g., several bytes or tens of bytes),
When the service type of the instant message (or QoS flow, traffic type/type, bearer type, etc.) satisfies a preconfigured condition,
When a logical channel identifier (LCID, logical channel ID), a bearer identifier (bearer ID), or a QoS flow ID, etc., corresponds to an identifier configured for an instant message,
When an uplink transmission timing condition for instant message transmission is satisfied,
When an instant message corresponds to an urgent service message, or,
When a measurement result of a radio channel satisfies a reference condition for instant message transmission. Here, the reference condition may refer to a radio channel quality condition configured as a parameter such as RSRP, RSRQ, CSI-RS, RSSI, or path loss.

When the terminal determines the PUR-based instant message transmission, or when the PUR-based instant message transmission is triggered or initiated, the terminal may transmit to the base station a resume request message configured identically to the resume request message described in the RA procedure-based instant message transmission method. The resume request message may be transmitted to the base station first when the terminal performs the PUR-based instant message transmission procedure. In addition, when an uplink instant message occurs, the base station and the terminal do not perform a new connection configuration step for transmission of the corresponding instant message or perform an operation procedure for state transition of the terminal, and the terminal may transmit the instant message through an uplink channel (i.e., a random access channel or a PUR preconfigured for instant message transmission), as described above.

Configuration information such as time-domain or frequency-domain radio resource allocation information, MCS information, or HARQ retransmission information for a PUR for instant message transmission may be delivered to the terminal by using system information or a dedicated control message (e.g., a control transmitted delivered for state transition). That is, the configuration information for a PUR for instant message transmission may be signaled to the terminal within a service area satisfying conditions configured by the base station through system information, a MAC CE, or a physical layer control channel (or, PDCCH, DCI, UCI, etc.). The PUR allocation information (such as time-domain or frequency-domain radio resource allocation information, MCS information, or HARQ retransmission information for the PUR) transmitted through a physical layer control channel may be transmitted according to a preconfigured period and/or through a designated PDCCH transmission region (e.g., CORESET or search space). The corresponding physical layer control channel may be transmitted using a scheduling identifier allocated to a specific terminal or a specific terminal group, or allocated for transmission of the PUR configuration information.

In addition, a radio resource for the above-described PUR may be limited only to a resource of a BWP that is previously designated or configured. In this case, the PUR configuration information may include a BWP index indicating the corresponding BWP. When a PUR for instant message transmission is configured using a default BWP, an initial BWP, and/or a PUR-dedicated BWP at a system level, the PUR configuration information may not include the BWP index. When a PUR-dedicated BWP is configured, the base station may transmit PUR-dedicated BWP configuration information to the terminal using system information or a dedicated control message.

In addition, when a PUR for instant message transmission is configured in an uplink BWP other than an initial uplink BWP, the corresponding BWP may be configured to have the same properties as the initial BWP. When a PUR is configured in a UL/SUL BWP other than the initial uplink BWP, a BWP in which the terminal in the inactive state receives a paging message, system information change notification, system information (e.g., SI, SIB, posSIB, etc.), or MBS services may vary according to the capability of the terminal.

### Case1: When the Terminal in the Inactive State Can Receive Only in One Downlink Bwp

The terminal should be able to receive a paging message, system information change notification, system information (e.g., SI, SIB, posSIB, etc.), or MBS services through a DL BWP corresponding to (or mapped) to the UL/SUL BWP in which the PUR is configured. Alternatively, the DL BWP corresponding to (or mapped) to the UL/SUL BWP in which the PUR is configured should be configured as an initial BWP.

### Case2: When the Terminal in the Inactive State Can Receive in Two or More Downlink BWPs

The terminal may receive a paging message, system information change notification, system information (e.g., SI, SIB, posSIB, etc.), or MBS services through an initial BWP other than a DL BWP corresponding to (or mapped) to the UL/SUL BWP in which the PUR is configured. Alternatively, the terminal may receive a control message for instant message transmission or feedback control information through a DL BWP corresponding to (or mapped) to the UL/SUL BWP in which the PUR is configured.

In the above-described instant message transmission, an encryption function according to a radio layer protocol may not be used or may be limitedly used in a radio section between the base station and the terminal. For example, an encryption function using an encryption key may not be applied, and only a function (e.g., integrity protection) to check integrity of a transmitted message may be applied.

When the base station transmits a downlink physical layer control channel (or PDCCH) to support a small data transmission (SDT) function in the above-described instant message transmission method based on RA procedure and/or PUR, a PDCCH (or DCI) transmission region (e.g., CORESET or search space) for supporting the SDT function may be configured to be separated from the existing CORESET or search space for other purposes. Accordingly, the terminal may receive a PDCCH (or DCI) for supporting the SDT function by monitoring a designated (or configured) CORESET or search space for supporting the SDT function.

In addition, in the above-described instant message transmission method based on RA procedure and/or PUR, when the condition(s) of using a PUR configured for instant message transmission are not satisfied, the instant message transmission using a PUR may be restricted even for the terminal to which a PUR for instant message transmission is configured. Here, the condition(s) of using a PUR may be configured as a combination of one or more among a condition that an area identifier for the above-described PUR configuration information is the same as an area identifier of a base station of a service area in which the terminal currently exists, uplink transmission timing condition for instant message transmission, a condition that a measurement result of a radio channel satisfies a reference for instant message transmission, and a condition that uplink physical layer synchronization is maintained. When the preconfigured condition(s) of using a PUR are not satisfied, the terminal may transmit an instant message by using the above-described RA procedure for instant message transmission, not a PUR for instant message transmission.

After completing instant message transmission based on the above-described RA procedure and/or PUR, the terminal may maintain the inactive state or transition to the idle state according to determination (or control) of the base station and/or a request of the terminal. When the terminal transitions to the idle state, the terminal may transition to the idle state without receiving the above-described PUR configuration information for instant message transmission. In the case that the terminal maintains the inactive state, the terminal may perform a PUR-based instant message transmission procedure when a next instant message packet occurs by using newly configured PUR configuration information or the existing PUR configuration information stored in the terminal.

The above-described instant message transmission method based on the RA procedure and/or PUR may be applied to a terminal in the connected state to which uplink resources are not allocated. That is, when the terminal in the connected state does not have allocated uplink radio resources or does not have a valid scheduling request (SR) resource for requesting an uplink resource, the terminal in the connected state may transmit an uplink instant message by using the RA procedure or PUR according to the above-described method and procedure. In the above-described instant message transmission based on the RA procedure and/or PUR, information on configuration parameters such as an instant message transmission period (or window, timer, counter), information indicating whether one-time transmission (or one-shot transmission) is allowed and/or information on the size (or number of messages) of an instant message that can be transmitted as one-time transmission, or information on the size (or number of messages) of an instant message that can be transmitted as segmented may be delivered to the terminal through system information and/or an RRC control message.

During one-time transmission of an instant message or segmented transmission of an instant message using two or more segments, the terminal may not perform a radio link failure (RLF) detection, radio link monitoring (RLM), beam failure detection and recovery, and the like. If instant message transmission is not completed within the instant message transmission period (or window, timer, counter), it may be determined that the instant message transmission has failed.

According to a size threshold (or condition value) of an uplink instant message configured for instant message transmission and/or a subsequent data transmission method for segmented transmission of instant data, the terminal may use one or more uplink resources to transmit an instant message. Accordingly, a time from the instant message transmission request to the completion of the instant message transmission may be longer than a time required for the existing procedure for resuming a radio link (e.g., resume procedure of the 3GPP LTE/NR system). Accordingly, at least one of the following methods may be considered as a timer-based method of managing (or detecting) a transmission failure of an instant message.
Method 1: Method of managing (or detecting) a transmission failure of an instant message based on an instant message timer
Method 2: Method of managing (or detecting) a transmission failure of an instant message based on the legacy radio link resume timer (e.g., T319 timer of the 3GPP LTE/NR system) and an instant message transmission timer

Method 1 is a method of managing (or detecting) whether instant message transmission has failed by using one instant message timer from a transmission time of the instant message transmission request message until the instant message transmission is completed. The instant message timer may be started or restarted whenever the terminal performs uplink transmission in order to support (or perform) the instant message transmission function. That is, the instant message timer may be started or restarted whenever the terminal is performing the RA procedure for instant message transmission or when the terminal performs transmission using a PUR and/or uplink resource scheduled by the base station. When the instant message transmission and/or each uplink transmission for the instant message is not completed until the instant message timer expires, the terminal and/or the base station may determine a transmission failure of the instant message.

For Method 2, an instant message transmission procedure may be divided into an instant message transmission initiation step and an instant message transmission execution step. The instant message transmission initiation step may refer to a period from a time at which a transmission request message (or, RA MSG3 or RA MSG-A according to the RA procedure) for an instant message is transmitted to a time at which a response message (or, RA MSG4 or RA MSG-B according to the RA procedure) to the instant message is received from the base station. The instant message transmission execution step may refer to a step in which the terminal transmits a data packet of the instant message by using an uplink radio resource. In the instant message transmission initiation step, the terminal may manage (or detect) whether the instant message transmission has failed by using the legacy radio link resume timer (e.g., T319 timer). Therefore, the resume timer may start at the time at which the transmission request message (or, RA MSG3 or RA MSG-A according to the RA procedure) for the instant message is transmitted, and may stop at the time at which the response message (or, RA MSG4 or RA MSG-B according to the RA procedure) to the instant message is received from the base station. If the response message is not received until the radio link resume timer expires, the terminal and/or the base station may determine a transmission failure of the instant message.

In the instant message transmission execution step, the terminal may manage (or detect) whether the instant message transmission has failed by using the instant message timer (or instant message instantaneous timer). The instant message timer (or instant message instantaneous timer) may be started or restarted whenever the terminal performs transmission through an uplink radio resource in order to support (or perform) the instant message transmission function. That is, the instant message timer (or instant message instantaneous timer) may be started or restarted every time the terminal transmits a data packet of an instant message by using a PUR and/or an uplink resource scheduled from the base station. When the transmission of the instant message data packet is not completed until the instant message timer (or instant message instantaneous timer) expires, the terminal and/or the base station may determine a transmission failure of the instant message. Therefore, in Method 2, by using the legacy radio link resume timer (e.g., T319 timer) and the instant message timer (or instant message instantaneous timer) for each step, it may be managed (or detected) whether or not the instant message transmission has failed.

If the instant message transmission has failed, after a preconfigured time period (or timer), in which the reattempt of the instant message transmission is restricted after the transmission failure of the instant message, ends (or expires), the terminal in the idle state or the inactive state may request the transmission of the instant message again or reattempt the transmission of the instant message. Information on the time period (or timer) in which the reattempt of the instant message transmission is restricted may be delivered to the terminal through system information and/or a control message. Alternatively, when the transmission of the instant message finally fails in the idle state or in the inactive state, the terminal may transition to the connected state and transmit the packet of the corresponding instant message. In this case, before or when the preconfigured transmission period (or window, timer, counter) of the instant message ends or when the end of the transmission period is recognized, the base station may indicate the terminal to transition to the connected state, or the terminal may transmit a control message requesting transition to the connected state to the base station or perform a connection configuration procedure such as an RA procedure.

Here, the counter (or timer) that manages the transmission period of the instant message may be started (or restarted) when the message requesting transmission of the instant message using the above-described RA procedure or PUR is transmitted, when the instant message is transmitted, at each transmission time when two or more instant messages are transmitted, or when an uplink resource for transmission of the instant message is allocated. In addition, the counter (or timer) that manages the transmission period of the instant message may be stopped when the terminal receives a response message to the message requesting transmission of the instant message (e.g., a response message for allowing, withholding, or rejecting the transmission of the instant message, or a message indicating a state transition for transmission of the corresponding data transmission).

In this case, a mapping relationship between the PUR for transmission of the instant message and the scheduling identifier (e.g., C-RNTI, CG-RNTI, PUR-RNTI, etc.) and/or DMRS configuration information assigned to the corresponding terminal (or terminal group) may be established. Here, the DMRS configuration information may refer to radio resources for DMRS transmission, a DMRS sequence, or a cyclic shift parameter. Configuration information on the mapping relationship may be delivered to the terminal using system information or a control message.

When the terminal configured to transmit an instant message using the above-described RA procedure or PUR needs to transmit an uplink data/control message other than an instant message, the terminal may transition to the connected state. For the transition to the connected state, the terminal may transmit a control message requesting the transition to the connected state to the base station according to at least one of the following methods.
A method of transmitting a control message requesting transition to the connected state by using an uplink resource allocated (or scheduled) according to the above-described RA procedure for instant message or a PUR
A method of transmitting a control message requesting transition to the connected state by using an uplink resource acquired through execution of a new RA procedure

The control message requesting the transition to the connected state may be a MAC layer or RRC layer control message. The RRC layer control message may be a control message requesting RRC resume or RRC connection re-establishment. The MAC layer control message may be configured in form of a MAC subheader and/or a MAC control element (CE). The MAC layer control message may include a MAC subheader of a specific format for transmitting the request message for transitioning the terminal in the inactive state to the connected state, an LCID configured for the corresponding purpose, an LCID for a DRB/SRB required for transmission of the request message, and/or buffer status information.

In the present disclosure, the radio channel quality may be a channel state indicator (CSI), a received signal strength indicator (RSSI), a reference signal received power (RSRP), a reference signal received quality (RSRQ), or a signal to interference and noise ratio (SINR). With respect to the operation of the timer defined or described in the present disclosure, although operations such as start, stop, reset, restart, or expire of the defined timer are not separately described, they mean or include the operations of the corresponding timer or a counter for the corresponding timer.

In the present disclosure, the base station (or cell) may refer to a node B (NodeB), an evolved NodeB, a base transceiver station (BTS), a radio base station, a radio transceiver, an access point, an access node, a road side unit (RSU), a radio remote head (RRH), a transmission point (TP), a transmission and reception point (TRP), or a gNB. In addition, the base station (or, cell) may a CU node or a DU node to which the functional split is applied.

In the present disclosure, the terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method for transmitting an instant message, performed by a terminal, the method comprising:
receiving configuration information related to instant message transmission from a base station;
determining whether transmission of an instant message is allowed when the instant message occurs; and
in response to determining that the transmission of the instant message is allowed, performing the transmission of the instant message by using a random access (RA) procedure or a pre-allocated uplink resource(s) (PUR(s)).

2. The method according to claim 1, wherein the instant message is intermittently occurring data or signaling information having a size equal to or less than a predetermined size.

3. The method according to claim 1, wherein in the performing of the transmission of the instant message, when the terminal is in a radio resource control (RRC) connected state or maintains uplink physical layer synchronization, the transmission of the instant message is performed by using the PUR(s).

4. The method according to claim 1, wherein in the performing of the transmission of the instant message, when the terminal is in an RRC inactive or RRC idle state or does not maintain uplink physical layer synchronization, the transmission of the instant message is performed by using the RA procedure without transition of the terminal to an RRC connected state.

5. The method according to claim 1, wherein in the performing of the transmission of the instant message, when the terminal is in an RRC inactive or RRC idle state, or does not maintain uplink physical layer synchronization, and the PUR(s) are PUR(s) in which instant message transmission of a terminal not maintaining uplink physical layer synchronization is allowed, the transmission of the instant message is performed by using the PUR(s).

6. The method according to claim 1, wherein an RA occasion and/or an RA preamble used in the RA procedure is configured differently from an RA occasion and/or an RA preamble of an RA procedure which is not for instant message transmission.

7. The method according to claim 6, wherein the RA preamble used in the RA procedure varies according to a size of the instant message and/or a channel quality between the terminal and the base station.

8. The method according to claim 1, further comprising, when the RA procedure is performed as a 4-step RA procedure,
transmitting information indicating a size of the instant message and whether the instant message is transmitted one-time or as segmented to the base station by using an RA MSG3 according to the 4-step RA procedure or a control message after the RA MSG 3;
receiving allocation information of an uplink resource for transmission of the instant message from the base station through an RA MSG 4 according to the 4-step RA procedure or a separate control message; and
transmitting the instant message to the base station using the uplink resource.

9. The method according to claim 1, further comprising, when the RA procedure is performed as a 2-step RA procedure,
transmitting information indicating a size of the instant message and whether the instant message is transmitted one-time or as segmented to the base station by using an RA payload of an RA MSG-A according to the 2-step RA procedure;
receiving allocation information of an uplink resource for transmission of the instant message from the base station through an RA MSG-B according to the 2-step RA procedure; and
transmitting the instant message to the base station using the uplink resource.

10. The method according to claim 1, wherein the configuration information includes information on whether the base station allows the RA procedure to be performed as a 2-step RA procedure or information on a radio channel quality condition for the terminal to perform the RA procedure as the 2-step RA procedure.

11. The method according to claim 1, wherein the PUR(s) are composed of physical uplink shared channel (PUSCH) resource(s) allocated to the terminal in a CG (configured grant) scheme.

12. The method according to claim 1, wherein the PUR(s) are composed of a PUSCH resource(s) and a preamble having a predetermined sequence, a reference signal, or pilot symbols.

13. The method according to claim 1, wherein the PUR(s) are configured for each area composed of at least one base station, and the PUR(s) are configured to the terminal together with an identifier identifying an area to which the PUR(s) are applied.

14. The method according to claim 1, wherein when the transmission of the instant message is performed by using the PUR(s), if the transmission of the instant message is not completed within a predetermined instant message transmission period, the transmission of the instant message transmission is determined as failed.

15. A method for receiving an instant message, performed by a base station, the method comprising:
transmitting configuration information related to instant message transmission to a terminal; and
in response to determining that the terminal in which an instant message occurs is allowed to transmit the instant message, receiving the instant message by using a random access (RA) procedure or a pre-allocated uplink resource(s) (PUR(s)).

16. The method according to claim 15, wherein in the receiving of the instant message, when the terminal is in a radio resource control (RRC) connected state or maintains uplink physical layer synchronization, the receiving of the instant message is performed by using the PUR(s).

17. The method according to claim 15, wherein in the receiving of the instant message, when the terminal is in an RRC inactive or RRC idle state, or does not maintain uplink physical layer synchronization, the receiving of the instant message is performed by using the RA procedure without transition of the terminal to an RRC connected state.

18. The method according to claim 15, wherein an RA occasion and/or an RA preamble used in the RA procedure is configured differently from an RA occasion and/or an RA preamble of an RA procedure which is not for instant message transmission.

19. The method according to claim 15, further comprising, when the RA procedure is performed as a 4-step RA procedure,
receiving information indicating a size of the instant message and whether the instant message is transmitted one-time or as segmented from the terminal by using an RA MSG3 according to the 4-step RA procedure or a control message after the RA MSG 3;
transmitting allocation information of an uplink resource for reception of the instant message to the terminal through an RA MSG 4 according to the 4-step RA procedure or a separate control message; and
receiving the instant message from the terminal using the uplink resource.

20. The method according to claim 15, further comprising, when the RA procedure is performed as a 2-step RA procedure,
receiving information indicating a size of the instant message and whether the instant message is transmitted one-time or as segmented from the terminal by using an RA payload of an RA MSG-A according to the 2-step RA procedure;
transmitting allocation information of an uplink resource for transmission of the instant message to the terminal through an RA MSG-B according to the 2-step RA procedure; and
receiving the instant message from the terminal using the uplink resource.
